(19) United States
(12) Patent Application Publication
(10) Pub. No.: US 2024/0102280 A1
(43) Pub. Date: Mar. 28, 2024

(54) PLANAR AND CORNER INSULATED CONCRETE FORMS, MONOLITHIC FORM SKELETON FRAME MODULES, AND RELATED METHODS OF USE AND MANUFACTURING

(71) Applicant: BENJAMIN BAADER, Onoway (CA)

(72) Inventor: BENJAMIN BAADER, Onoway (CA)

(21) Appl. No.: 18/029,601

(22) PCT Filed: Sep. 30, 2021
(86) PCT No.: PCT/CA2021/051370

§ 371 Date: Mar. 30, 2023

Related U.S. Application Data
(60) Provisional application No. 63/086,028, filed on Sep. 30, 2020.

(51) Int. Cl. E04B 2/86

(52) U.S. Cl. CPC E04B 2/8635; E04B 2103/04

(57) ABSTRACT

Integrally molded insulated concrete form skeleton modules are discussed, along with various other insulated concrete form skeletons and related methods and technologies. Insulated concrete corner forms are discussed, and ways to make same are also discussed. One or both folding and cutting steps may be used to create a corner form from a planar form, or from two independent concrete forms.

### TECHNICAL FIELD

The present application relates generally to apparatuses, systems and methods for constructing an insulated concrete form. More particularly, it relates to a system and method for constructing monolithic insulated concrete forms.

### BACKGROUND DESCRIPTION

This section provides background information to facilitate a better understanding of the various aspects of the present technology. The following paragraphs are not an admission that anything discussed in them is prior art or part of the knowledge of persons skilled in the art.

Insulating concrete forms or insulated concrete forms (ICF) are a system of formwork for reinforced concrete usually made with a rigid thermal insulation that stays in place as a permanent interior and exterior substrate for walls, floors, and roofs. The forms are interlocking modular units that are dry-stacked (without mortar) and filled with concrete. The units lock together somewhat like Lego bricks and create a form for the structural walls or floors of a building. ICF construction has become commonplace for both low rise commercial and high-performance residential construction as more stringent energy efficiency and natural disaster resistant building codes are adopted.

ICFs are modular system for reinforced concrete that stays in place as permanent interior and exterior walls, floors and roofs. Insulated concrete form units are connected together as needed and filled with concrete. Insulated concrete forms have an interior skeleton assembly and exterior molded walls. The exterior molded walls are generally made of polystyrene foam, polyurethane foam, cement-bonded wood fiber, cement-bonded polystyrene beads, cellular concrete or thermos-acoustic-styro-concrete 20 (THASTRYON) being a mixture of cement, water and recycled expanded polystyrene.

Insulated concrete form walls are constructed one row at a time with modular units being placed in end-to-end relation with each other for the length of the wall. Interior and exterior finishes such as siding and drywall can be affixed directly to the exterior molded walls of the insulated concrete forms.

### BRIEF SUMMARY OF THE PRESENT TECHNOLOGY

An apparatus is disclosed comprising: a concrete form skeleton frame module, having: a ladder, formed of opposed side beams laterally spaced from one another by a plurality of bridge beams; and a plurality of studs, arrayed and spaced from one another along a longitudinal length of exterior sides of the opposed side beams of the ladder; in which the opposed side beams define first and second ladder ends of the ladder, with each of the first and second ladder ends having a ladder connector, with the ladder connectors of the first and second ladder ends being adapted to mechanically connect to ladder connectors of second and first ladder ends, respectively, of a ladder of a second concrete form skeleton frame module, which is identical to the concrete form skeleton frame module, if the second concrete form skeleton frame module is positioned in use adjacent the concrete form skeleton frame module such that the first or second ladder ends of the concrete form skeleton frame module abut the second or first ladder ends, respectively, of the second concrete form skeleton frame module; in which the plurality of studs each define first and second stud ends, with each of the first and second stud ends having a stud connector, with the stud connectors of the first and second stud ends being adapted to mechanically connect to stud connectors of second and first stud ends, respectively, of a plurality of studs of a third concrete form skeleton frame module, which is identical to the concrete form skeleton frame module, if the third concrete form skeleton frame module is positioned in use adjacent the concrete form skeleton frame module such that the first or second stud ends of the concrete form skeleton frame module abut the second or first stud ends, respectively, of the third concrete form skeleton frame module; and in which the concrete form skeleton frame module is integrally formed as a monolithic unit. A mold is disclosed structured to form a concrete form skeleton frame module. A method is disclosed comprising molding a concrete form skeleton frame module.

A mold assembly is disclosed for molding insulated concrete forms, comprising: an outer housing having a bottom support base, a first side wall and a second side wall defining an interior cavity, the outer housing having an entrance and an exit for access to the interior cavity; first and second mold lids; first and second entrance doors; first and second pluralities of downward oriented extensions, each of the first and second pluralities downward oriented extensions being movable between a retracted position and an inserted position, in which, when the first and second pluralities of downward oriented extensions are in the inserted position, with the first and second pluralities of downward oriented extensions inserted into a series of spaces defined by and along opposed sides of an insulated concrete form skeleton frame that is located within the interior cavity in use, first and second mold cavities are defined by the first and second mold lids, the first and second entrance doors, the first and second pluralities of downward oriented extensions, and the insulated concrete form skeleton frame; fill guns oriented for injecting insulating polymeric material into the first and second mold cavities; and a blocking part used to seal the exit of the mold assembly during molding of a first insulated concrete form.

A method of making an insulated concrete corner form is disclosed, the method comprising: abutting ends of first and second insulated concrete forms, with the first and second insulated concrete forms oriented in a corner configuration, and exterior and interior abutment interfaces defined between the ends of the first and second insulated concrete forms; and securing outer and inner corner angle members to the exterior faces and interior faces, respectively, of the first and second insulated concrete forms, with the outer and inner corner angle members bridging the exterior and interior abutment interfaces, respectively.

An insulated concrete corner form is disclosed comprising: first and second insulated concrete forms, whose ends abut one another with the first and second insulated concrete forms oriented in a corner configuration, and exterior and interior abutment interfaces defined between the ends of the first and second insulated concrete forms; and outer and inner corner angle members secured to the exterior faces and interior faces, respectively, of the first and second insulated concrete forms, with the outer and inner corner angle members bridging the exterior and interior abutment interfaces, respectively.

In various embodiments, there may be included any one or more of the following features: The concrete form skeleton frame module is integrally molded as a monolithic unit. The ladder connectors and the stud connectors are male-female connectors. The first, second, or first and second ladder ends comprise apertures to permit a fastener to pass through to secure the concrete form skeleton frame module and the second concrete form skeleton frame module together. The stud connectors are irreleasable connectors. The plurality of studs comprise three or more studs along each of the opposed side beams of the ladder. The ladder is oriented horizontally and the plurality of studs are oriented vertically. A plurality of concrete form skeleton frame modules connected together to form a concrete form skeleton frame via connections between the ladder connectors or stud connectors of adjacent concrete form skeleton frame modules of the concrete form skeleton frame. A plurality of lateral stems extends from the exterior sides of the opposed side beams to interior sides of the plurality of studs to separate the interior sides of the plurality of studs from the opposed side beams of the ladder to define opposed insulated form panel gaps therebetween. Opposed insulated form panels, each having exterior and interior faces, with the interior faces mounted to the ladder and spaced apart from one another to form an insulated concrete form. The opposed insulated form panels comprise expandable polymer material. The plurality of studs and the opposed side beams are embedded within the opposed insulated form panels. Each stud of the plurality of studs is fifteen inches tall or less. Forming a concrete form skeleton frame by connecting adjacent concrete form skeleton frame modules together. Molding opposed insulated form panels to the apparatus, each of the opposed insulated form panels having exterior and interior faces, with the interior faces mounted to the ladder and spaced apart from one another to form an insulated concrete form. Cutting the insulated concrete form to length or height. Cutting the exterior face along an exterior cut plane that is: parallel with the corner axis; and parallel with and intermediate between opposed side edges of the insulated concrete form. The insulated concrete form comprises opposed insulated form panels separated by a concrete form skeleton frame; cutting comprises cutting an exterior panel of the opposed insulated form panels; the concrete form skeleton frame forms a bridge between the first and second corner wing portions; and during folding the concrete form skeleton frame folds to assume the corner configuration. Cutting comprises cutting interior and exterior faces of the insulated concrete form. Cutting comprises: cutting the exterior face along an exterior cut plane that is parallel with and intermediate between opposed side edges of the insulated concrete form; and cutting the interior face along two interior cuts, which do not pass through the exterior cut plane, with one interior cut located on one side, and the other interior cut located on the other side, of the exterior cut plane. The interior cuts are angled toward the exterior cut plane with increasing depth within the interior face. The corner configuration is a ninety-degree corner and the interior cuts are angled at one hundred thirty-five degrees relative to a normal defined by the interior face. Cutting comprises moving the insulated concrete form on a conveyor past a cutting element. Folding comprises: positioning the insulated concrete form on a folding table, the folding table having first and second folding panels that connect to pivot relative to another about a pivot axis, with the first corner wing portion located on the first folding panel and the second corner wing portion located on the second folding panel; and pivoting the first and second folding panels about the pivot axis to fold the first and second corner wing portions. Folding the first and second corner wing portions are secured to the first and second folding panels. Securing further comprises adhering the first and second corner wing portions together along the corner axis of the insulated concrete form. After folding and before securing, the first and second corner wing portions define a corner groove along the corner axis; and adhering comprises applying an adhesive into the corner groove. Adhesive comprises polyurethane. Adhering comprises using an actuator to translate a spray nozzle along a longitudinal length of the corner groove to apply the adhesive. Securing further comprises inserting and securing a corner column into the corner groove. The insulated concrete corner form defines first and second corner wing portions that are angled relative to one another about a corner axis; the concrete form skeleton frame forms a bridge between the first and second corner wing portions, with the concrete form skeleton frame bent about the corner axis to assume the corner configuration. The first and second corner wing portions are secured together with adhesive. The concrete receiving cavity extends continuously from the first corner wing portion to the second corner wing portion. The folding structure further comprises an adhesive applicator structured to apply adhesive along a longitudinal length of the corner axis of the insulated concrete form. The adhesive applicator comprises an actuator mounted to translate a spray nozzle along the longitudinal length of the corner axis to apply the adhesive. A staging conveyor oriented to convey the insulated concrete form from the cutting exit of the cutting structure to a folding entrance of the folding structure. An ejection conveyor oriented to convey the insulated concrete form from a folding exit of the folding structure. Folding structure further comprises locking parts on the folding table for securing the first and second corner wing portions to the first and second panels. Fill guns comprise pluralities of fill guns spaced on the first and second mold lids. The first and second pluralities of downward oriented extensions have removable spacer plates to reduce buckling as well as adjust the interior size of the first and second mold cavities. The first and second pluralities of downward oriented extensions are mounted on the first and second mold lids, respectively. The first and second pluralities of downward oriented extensions are structured to translate vertically between the retracted and inserted positions. Ejection rollers at the exit. The blocking part comprises a rubber block plug. The fill guns comprise foam guns for filling foam beads in the first and second mold cavities; and further comprising: a steam inlet for injecting steam into the first and second mold cavities; and a cold air inlet for cooling down the molded insulated concrete form using sensor-aided thermoelectric coolers and aluminum fins. An adjustable spacer between the first and second pluralities of downward oriented extensions for adjusting the first and second mold cavities in size. Each of the outer and inner corner angle members have first and second corner wings defined about a respective angle member corner axis, in which securing comprises securing the first and second corner wings to the first and second insulate concrete forms, respectively. Securing comprises passing one or more fasteners through: the first corner wing of the outer corner angle member; the first insulated concrete form; and the first corner wing of the inner corner angle member. Securing comprises passing one or more fasteners through: the second corner wing of the outer corner angle member; the second insulated concrete form; and the second corner wing of the inner corner angle member. Securing comprises passing one or more fasteners through both the outer corner angle member and the inner corner angle member. Securing comprises passing one or more fasteners through the respective angle member corner axes of both the outer corner angle member and the inner corner angle member. Securing comprises passing one or more fasteners through both the first and second corner wings of the outer corner angle member. Fasteners are secured by nuts. Concrete receiving cavities defined by the first and second concrete forms are linked to form a continuous concrete receiving cavity; and further comprising pouring concrete into the continuous concrete receiving cavity. Removing one or both of the outer and inner corner angle members after the concrete sets. The outer and inner corner angle members are secured by fasteners and nuts, and in which removing comprises removing the nuts, removing the one or both of the outer and inner corner angle members, and cutting off protruding ends of the fasteners. For each of the outer and inner corner angle members, each of the first and second corner wings comprise lateral fingers spaced to define gaps between adjacent fingers. The lateral fingers define apertures, and in which securing further comprises securing fasteners through the apertures into the first and second insulated concrete forms. Prior to securing, forming plural outer corner angle members by: cutting out plural outer corner angle members in a flat configuration from a sheet of material, with lateral fingers intermeshing between adjacent outer corner angle members prior to cutting; and bending each of the plural outer corner angle members about the respective angle member corner axis. Prior to securing, forming plural inner corner angle members by: cutting out plural inner corner angle members in a flat configuration from a sheet of material, with lateral fingers intermeshing between adjacent inner corner angle members prior to cutting; and bending each of the plural inner corner angle members about the respective angle member corner axis. Adhering the abutted ends of the first and second insulated concrete forms together along the exterior and interior abutment interfaces. Prior to abutting, forming the first and second insulated concrete forms by cutting an insulated concrete form. Concrete receiving cavities defined by the first and second concrete forms are linked to form a continuous concrete receiving cavity; and further comprising inserting rebar within the continuous concrete receiving cavity to follow the corner configuration and laterally extend between the first and second concrete forms. Each of the outer and inner corner angle members have first and second corner wings defined about a respective angle member corner axis, with the first and second corner wings securing the outer and inner corer angle members to the exterior faces and interior faces, respectively, of the first and second insulate concrete forms. One or more fasteners are passed through: the first corner wing of the outer corner angle member; the first insulated concrete form; and the first corner wing of the inner corner angle member. One or more fasteners are passed through: the second corner wing of the outer corner angle member; the second insulated concrete form; and the second corner wing of the inner corner angle member. The first and second corner wings comprise lateral fingers spaced to define gaps between adjacent fingers. The lateral fingers define apertures, and in which fasteners are secured through apertures into the first and second insulated concrete forms. The abutted ends of the first and second insulated concrete forms are adhered together along the exterior and interior abutment interfaces. The first and second concrete forms each comprise: a concrete form skeleton frame; and opposed insulated form panels, each having exterior and interior faces, with the interior faces mounted to opposed sides of the concrete form skeleton frame and spaced apart to define a concrete receiving cavity therebetween; and the concrete receiving cavities of the first and second concrete forms are linked to form a continuous concrete receiving cavity. On each of the first side and the second side of the strap loading assembly there are at least two feeders positioned parallel to one another and spaced vertically from each other. The number of strap guides in the press assembly is the same as the number of strap guides in the strap loading assembly. There are at least two ladder guides positioned parallel to one another and spaced horizontally from each other. The first side and the second side of the strap loading assembly are substantially the same. The straps are movable in use along the strap guides of the strap loading assembly by an actuator. The actuator comprises a ram that has a vertical pushing arm for contacting all of the straps in use within the strap guides on first side or second side of the strap loading assembly. The strap guides of the press assembly have rollers for moving the straps. The rollers are driven by electric motors. Automated means of loading straps into the loading end of the feeders of the strap loading assembly. Automated means of loading strap receiving ladders into the loading end of the ladder guides of the ladder loading assembly. At least one of the first side of the press assembly and the second side of the press assembly are movable by pneumatic pistons. The first side of the press assembly and the second side of the press assembly are movable to press in use the straps and strap receiving ladder into connection with each other. In use the first side of the press assembly remains stationary and the second side of the press assembly is movable for pressing the at straps and the strap receiving ladder into connection with each other. One or both of the strap guides and press assembly strap guides comprise guide channels. The press assembly guides have a stop for positioning the straps within the press assembly guides such that the straps and the strap receiving ladder are aligned for connection. Ejection rollers are provided for ejecting the insulated concrete form skeleton. A staging area has a support structure, the support structure having a base, a first wall and a second wall defining an adjustable staging guide, the support structure having an entrance end and an exit end for access to the staging guide, the entrance end of the staging area being positioned adjacent to the press assembly for accepting the insulated concrete form skeleton from the press assembly, the exit end being positioned adjacent to the entrance of the mold assembly for guiding the insulated concrete form skeleton into the mold assembly. The staging area further comprises a form drive for moving the insulated concrete form skeleton through the staging area. The form drive comprises rollers positioned adjacent the exit end of the staging area, the rollers being driven by motors. The ladder connectors comprise female grooves and male tongues, with the female grooves. The female groove opens in a direction parallel to an axis of the opposed side beams. The male tongue comprises a lateral shelf. One or both of the female groove and male tongue are tapered in width in a direction toward the other of the female groove and male tongue when connected. Each stud comprises one or more reinforcing ridges. The one or more reinforcing ridges are parallel to an axis of the stud. The one or more reinforcing ridges are on an exterior face of the stud. The one or more reinforcing ridges project from a stud body of the stud. The one or more reinforcing ridges and stud body define foam cavities. The foam cavities are bounded by the one or more reinforcing ridges. A base of each foam cavity is defined by the stud body. The one or more reinforcing ridges comprise a plurality of axial ridges. The one or more reinforcing ridges comprise a plurality of cross ridges. The stud connectors comprise buckles. Each opposed side beam comprises one or more reinforcing ridges. The one or more reinforcing ridges comprise a plurality of axial ridges. The axial ridges extend a longitudinal length of the opposed side beam. The one or more reinforcing ridges comprise a lattice of structural members. The lattice is oriented in a plane perpendicular to the exterior side of the opposed side beam. Each stud mounts to an opposed side beam via the lattice. An interior face of the studs mount to an exterior edge of the lattice. Each stud mounts to an opposed side beam via a lateral stem. The lateral stem comprises a triangular gusset plate. The lateral stem is oriented such that an apex of the lateral stem is adjacent to the opposed side beam and a long edge of the lateral stem is adjacent an interior face of the stud. The plurality of bridge beams each comprise a plurality of one-way rebar connectors. The one-way rebar connectors comprise tapered spring tabs that are able to flex outwardly to receive the rebar, and close thereafter in order to enclose the rebar within a rebar slot.

There has thus been outlined, rather broadly, features of the present technology in order that the detailed description thereof that follows may be better understood and in order that the present contribution to the art may be better appreciated. Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings. As such, those skilled in the art will appreciate that the conception, upon which this disclosure is based, may readily be utilized as a basis for the designing of other structures, methods and systems for carrying out the several purposes of the present technology. It is, therefore, that the claims be regarded as including such equivalent constructions insofar as they do not depart from the spirit and scope of the present technology. The foregoing summary is not intended to summarize each potential embodiment or every aspect of the subject matter of the present disclosure. These and other aspects of the device and method are set out in the claims. These together with other objects of the present technology, along with the various features of novelty that characterize the present technology, are pointed out with particularity in the claims annexed to and forming a part of this disclosure. For a better understanding of the present technology, its operating advantages and the specific objects attained by its uses, reference should be made to the accompanying drawings and descriptive matter in which there are illustrated embodiments of the present technology.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the present technology to the particular embodiments shown. Embodiments will now be described with reference to the figures, in which like reference characters denote like elements, by way of example, and in which:

FIGS. 1 and 2 are perspective upper and lower views of a concrete form skeleton frame module with three studs on each side. FIG. 1A is a perspective view of a mold used to make the module of FIG. 1. FIG. 1B is schematic of an assembly for assembling plural modules of FIG. 1 together to construct a concrete form skeleton frame. FIG. 3 is a top plan view of the frame module of FIG. 1. FIGS. 3A, 3B, and 3C are close up views of the respective dashed areas from FIG. 3. FIGS. 4-5 are right and left side elevation views of the frame module of FIG. 1. FIG. 6 is a cross-sectional view taken along the 6-6 lines of FIG. 5. FIGS. 7 and 8 are perspective lower views of a concrete form skeleton frame module with seven studs on each side. FIG. 9 is a top plan view of the concrete form skeleton frame module of FIG. 7. FIG. 10 is a side elevation view of the concrete form skeleton frame module of FIG. 7. FIGS. 11 and 12 are perspective and side elevation cut away views, respectively, of an insulated concrete form made with four of the concrete form skeleton frame modules of FIG. 1 with a pair of insulated panels molded to either side of the skeleton frame. FIG. 13 is a top plan cut away view of the form of FIG. 11. FIG. 14 is a side elevation view of the form of FIG. 11. FIGS. 15 and 16 are perspective and side elevation cut away views, respectively, of an insulated concrete form made with four of the concrete form skeleton frame modules of FIG. 7 with a pair of insulated panels molded to either side of the skeleton frame. FIG. 17 is a side elevation view of the form of FIG. 15. FIGS. 18 and 19 are front and side elevation cut away views of an insulated concrete corner frame. FIG. 20 is a perspective view of a mold used in the construction of insulated concrete forms. FIG. 21 is an entrance side elevation view of the mold shown in FIG. 20. FIG. 22 is an exit side elevation view of the mold shown in FIG. 20. FIG. 23 is a side elevation view of the mold shown in FIG. 20. FIG. 24 is a perspective view of the mold shown in FIG. 20 in a closed position. FIG. 25 is a perspective view of the mold shown in FIG. 20 in the open position. FIG. 26 is a perspective view, partially in section, of the mold shown in FIG. 20. FIG. 27 is a perspective view of a staging area used in the system for constructing monolithic insulated concrete forms. FIG. 28 is an end elevation view of the staging area shown in FIG. 27. FIG. 29 is a detailed view of a portion of the staging area shown in FIG. 28. FIGS. 30, 30A and 30B are views of the cooling system and method FIGS. 31 and 31A are a depiction of the method of separation between the cooling side and steam face. FIG. 32 is a depiction of the method used for expansion and contraction during heating cycles. FIGS. 33 and 34 are perspective views of a concrete form skeleton frame module with four long studs and three short, inset studs, on each side. FIG. 35 is a top plan view of the frame module of FIG. 33. FIG. 36 is a side elevation views of the frame module of FIG. 33 FIGS. 37 and 38 are perspective views of a concrete form skeleton frame module with two long studs and one short, inset stud, on each side. FIG. 39 is a top plan view of the frame module of FIG. 37. FIGS. 39A and 39B are close up views of the respective dashed areas from FIG. 39. FIG. 40 is a side elevation view taken along the 40-40 dashed lines of FIG. 39 showing the second end of the ladder in the embodiment. FIG. 41 is a side elevation view of the frame module of FIG. 37. FIG. 41A is a close up view of the respective dashed area from FIG. 41. FIG. 42 is an end view of a further embodiment of a monolithic concrete form skeleton frame module. FIG. 43 is a lower perspective view of the skeleton frame module of FIG. 42. FIG. 44 is an upper perspective view of the skeleton frame module of FIG. 42. FIG. 45 is a side elevation view of the skeleton frame module of FIG. 42. FIG. 46 is a top plan view of the skeleton frame module of FIG. 42. FIG. 47 is an end view of a further embodiment of a monolithic concrete form skeleton frame module. FIG. 48 is a lower perspective view of the skeleton frame module of FIG. 47. FIG. 49 is an upper perspective view of the skeleton frame module of FIG. 47. FIG. 50 is a side elevation view of the skeleton frame module of FIG. 47. FIG. 51 is a top plan view of the skeleton frame module of FIG. 47. FIG. 52 is an end view of a further embodiment of a monolithic concrete form skeleton frame skeleton frame module. FIG. 53 is a lower perspective view of the skeleton frame module of FIG. 52. FIG. 54 is an upper perspective view of the skeleton frame module of FIG. 52. FIG. 55 is a top plan view of the skeleton frame module of FIG. 52. FIG. 56 is a side elevation view of the skeleton frame module of FIG. 52. FIG. 57 is an end view of a monolithic concrete form skeleton frame module. FIG. 58 is a lower perspective view of the skeleton frame module of FIG. 57. FIG. 59 is an upper perspective view of the skeleton frame module of FIG. 57. FIG. 60 is a top plan view of the skeleton frame module of FIG. 57. FIG. 61 is a side elevation view of the skeleton frame module of FIG. 57. FIG. 62 is an end view of a further embodiment of a monolithic concrete form skeleton frame module. FIG. 63 is a lower perspective view of the skeleton frame module of FIG. 62. FIG. 64 is an upper perspective view of the skeleton frame module of FIG. 62. FIG. 65 is a top plan view of the skeleton fame module of FIG. 62. FIG. 66 is a side elevation view of the skeleton frame module of FIG. 62. FIG. 67 is an end view of a skeleton form formed by three of the skeleton frame modules of FIG. 47 connected together. FIG. 68 is a side elevation view of the skeleton form of FIG. 67. FIG. 69 is an upper perspective view of the skeleton form of FIG. 67. FIG. 70 is a lower perspective view of the skeleton form of FIG. 67. FIG. 71 is a top plan view of the skeleton form of FIG. 67. FIG. 72 is a cross sectional view take along the section lines 72 in FIG. 71. FIG. 73 is a sheet of material with profiles of plural inside corner angle beams delineated in a flat configuration with lateral fingers enmeshed. FIG. 74 is a side elevation view of an inside corner angle beam cut from the sheet of material of FIG. 73 and shown in a flat configuration. FIG. 75 is a sheet of material with profiles of plural outside corner angle beams delineated in a flat configuration with lateral fingers enmeshed. FIG. 76 is a side elevation view of an outside corner angle beam cut from the sheet of material of FIG. 75 and shown in a flat configuration. FIG. 77 is a perspective view of the outside corner angle beam of FIG. 76 bent into a corner configuration. FIG. 78 is a top plan section view of an insulated concrete corner form with the inside and outside corner angle beams of FIGS. 75 and 77, respectively, secured to the exterior and interior surfaces of the corner form, showing fasteners passed through the forms on either side of the corner. FIG. 80 is a top plan section view of another corner concrete form, with fasteners (tie-rods) criss-crossing for corner stiffness. FIGS. 81-83 are sheets of material with profiles of corner angle beams.

### DETAILED DESCRIPTION OF THE PREFERRED EMBODIMENTS

A system for constructing monolithic insulated concrete forms will now be described with reference to the figures. Immaterial modifications may be made to the embodiments described here without departing from what is covered by the claims.

Concrete forms have long been used as formwork for the construction of concrete structures, such as the walls or floors of a building. Traditional form systems typically entail setting up two spaced apart form panels and pouring concrete into the space created between the panels. After the concrete hardens, the forms are removed, leaving the cured concrete wall. Traditional systems, however, have several drawbacks including the time required to erect the forms, the time for the concrete to cure, and the time to take down the forms, making the process expensive and labor-intensive.

Many modular insulated concrete form (ICF) systems have been developed to overcome the drawbacks of traditional form systems. Modular ICF systems typically comprise setting up the form system, generally classified as either “block” or “panel” systems, pouring the concrete into the space between the forms and leaving the form in place. As such, the insulating form becomes a permanent part of the structure after the concrete cures. Modular ICF systems are increasingly popular because they serve to insulate the concrete structure in addition to containing the fluid concrete as it solidifies, reducing the time and cost required to create the structure.

“Block” ICF systems typically comprise preassembled blocks having two expanded polystyrene (EPS) foam members connected together with ties or webs, wherein the ties or webs create a cavity between the two foam members for receiving fluid concrete. The ties or webs connecting the panels together can be molded to the foam members during the manufacturing process. As such, block ICF systems are often referred to as “fixed-tie” systems, and the blocks are installed at the construction site by stacking the blocks one on top of another (in a staggered fashion similar to the assembly of a brick wall). Blocks are then affixed together by fastening the webs of one block to the webs of an adjacent block manually, often with cable-ties.

As a result of the manufacturing process, however, the size, shape and cavity size of EPS blocks are limited by the molding machine used to create the block. Further, stacking multiple blocks one atop the other creates a plurality of joints between the blocks, reducing the overall strength of the wall, increasing the risk of vertical or horizontal skewing, and making the incorporation of design elements, such as windows, doors, corners etc., difficult.

“Panel” ICF systems are often constructed to be longer (e.g. taller) than block systems for faster installation. A number of variations of modular panel ICF systems and methods for their use have been developed. Typically, such panel ICF systems use two opposed EPS foam panels manufactured from commercially available pre-formed expanded polystyrene slabs connected together with spacers to form a cavity for receiving concrete between the two panels. The polystyrene slabs are cut down to size using a hot-wire cutting process and the spacers connecting the panels together are extruded to the desired size/shape from plastic materials before being affixed to the panels. The spacers are either fastened to the interior surface of the panels, or extend through the panels themselves, to create the cavity therebetween. Spacers or “bridging members” are known to have varying shapes, sizes, and strengths, often being used to reinforce the building structure.

Panel ICF systems allow for the manufacture of larger panels, resulting in easier and faster installation at the construction site. The panels can also be stacked one on top of the other (many stories high) to form the concrete structure. Larger panels also reduce the number of joints between panels and the risk of the wall skewing, increasing the overall strength of the wall. Design elements, such as doors and corners, are also easier to incorporate in panel structures. Although the prior art proposes variations to achieve improvements with concrete form systems, however, many drawbacks still exist.

By way of example, Canadian Patent Application No. 2,597,832 describes a panel ICF system where two panels are connected together by individual internal spacers coupled to individual external studs protruding through the panel and held together by external support straps. Both panels are pre-formed and cut from an EPS slab to the desired panel size and shape, including the apertures through the panels for receiving the internal spacers/external studs. At the construction site, the worker must first line the two panels up then manually position each individual spacer into the apertures of both panels. This laborious process requires that cutting of the panels be extremely precise to achieve proper alignment of the spacers/studs and apertures for receiving same.

A similar system is described in U.S. patent application Ser. No. 12/200,846, however the individual spacers are mounted on a common spacer “frame” (extending vertically up the interior surface of the panel). Use of the spacer frame provides simpler installation than having to align a plurality of individual spacers. Although somewhat easier to install, the panel system nonetheless requires detailed positioning and cutting of the pre-formed panels and the apertures therethrough for receiving the internal spacer “frame” and corresponding studs. The system is also held together by external connector straps. U.S. Pat. No. 10,006,200 describes an insulated concrete form panel system, made of studs that mate via irreleasable connectors to bridge members. Both studs and bridge members are molded separately and then press fit together.

Despite the benefits provided by known panel ICF systems, the manufacturing process of cutting panels from standard EPS creates waste of excess material and must be accurate (e.g. placement of apertures for receiving spacers, and positioning of spacers with corresponding external stud and strapping) for on-site assembly of the panel structure to be efficient and successful. One further disadvantage common to the prior art is the limited ability to readily vary the spacing between the side panels of the forms, and therefore the thickness of the concrete wall, as well as varying the strength, height, and length of the wall, and an inability to form corners.

There is a need for an improved ICF panel system and a process of making same, the system being capable of being manufactured into one continuous section for easy installation in the structure. It is desired that such a system could provide an internal stabilizing frame for use as a mold to receive expandable polystyrene material, such that the frame becomes integral to the panels molded thereto. Such a system may provide for easy assembly of pre-formed panels at the construction site, without the panels being limited in size or shape. Corner forms may be produced for any angle or dimension of corner. Modular forms may be produced that connect one to the other to provide any size, shape, dimension, and complexity of the resulting form and hence concrete wall, at the construction site.

In seismic and hurricane-prone areas, ICF construction provides strength, impact-resistance, durability, excellent sound insulation, and airtightness. ICF construction is ideal in moderate and mixed climates with significant daily temperature variations, in buildings designed to benefit from thermal mass strategies. Insulating R-Value alone (R-value) of ICFs range from R-12 to R-28, or more, which can be a good R-value for walls. The energy savings compared to framed walls may be in a range of 50% to 70% or higher.

The present insulated concrete form system and method of making same relate to the fabrication of concrete walls, foundations, floors, roofs, fences, artwork, and other concrete structures. Apparatus and methodologies more particularly described herein are intended as illustrative only since numerous modifications and variations therein will be apparent to those skilled in the art.

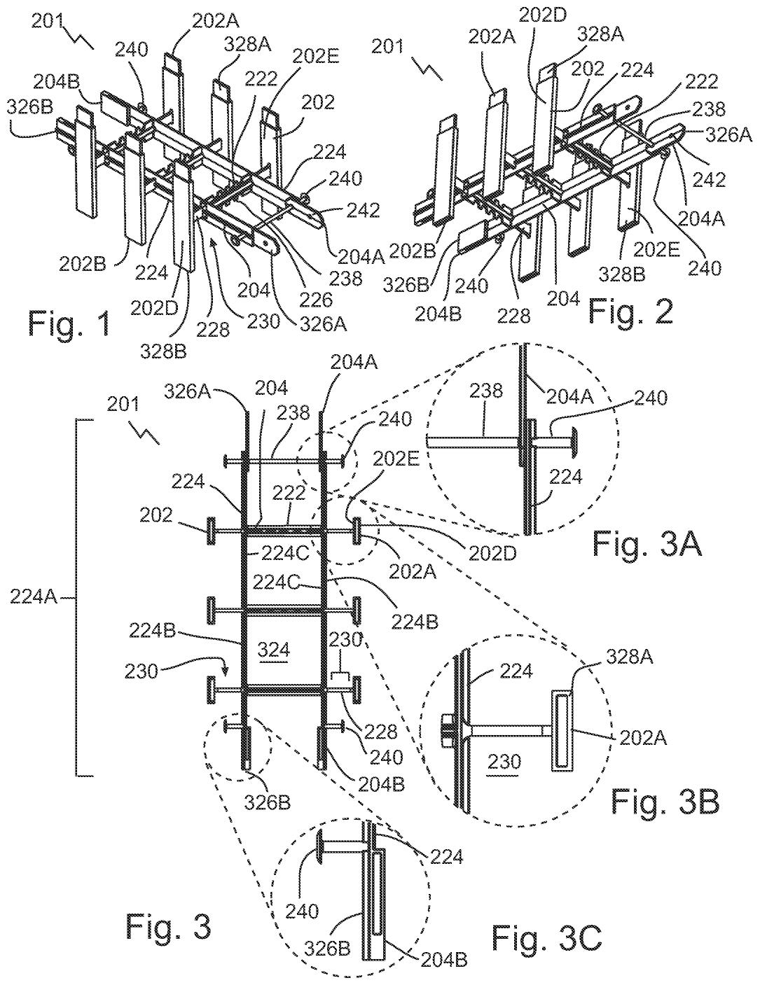

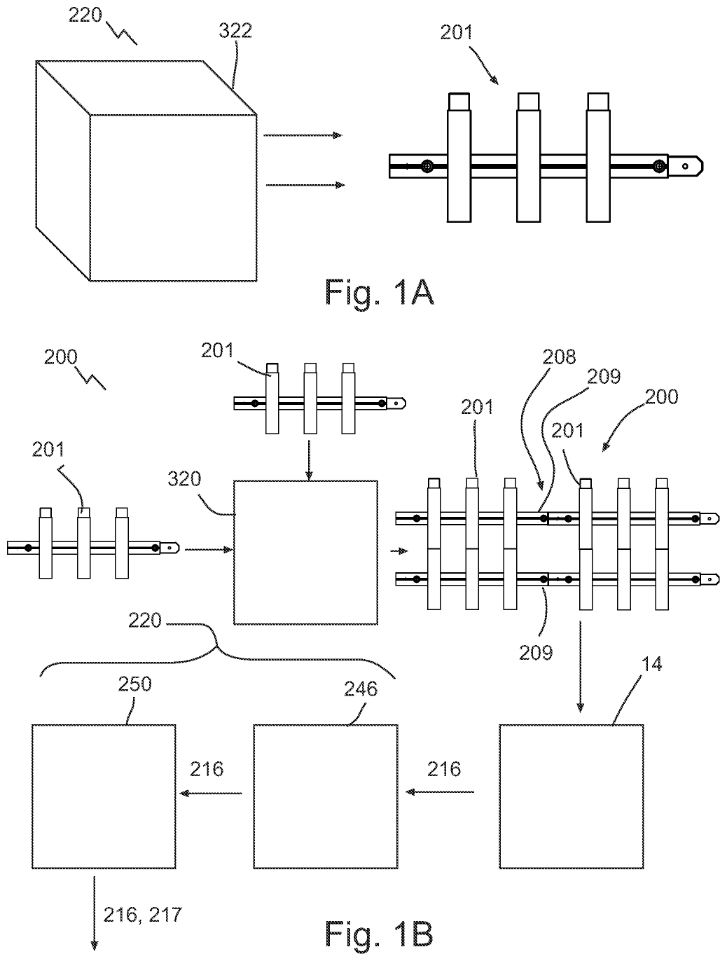

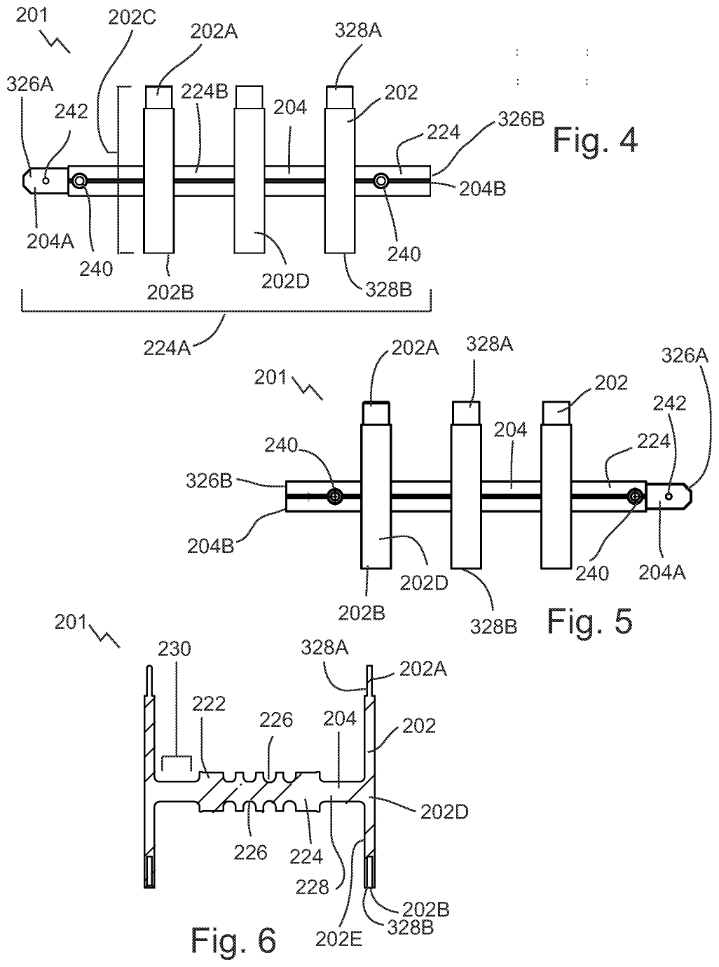

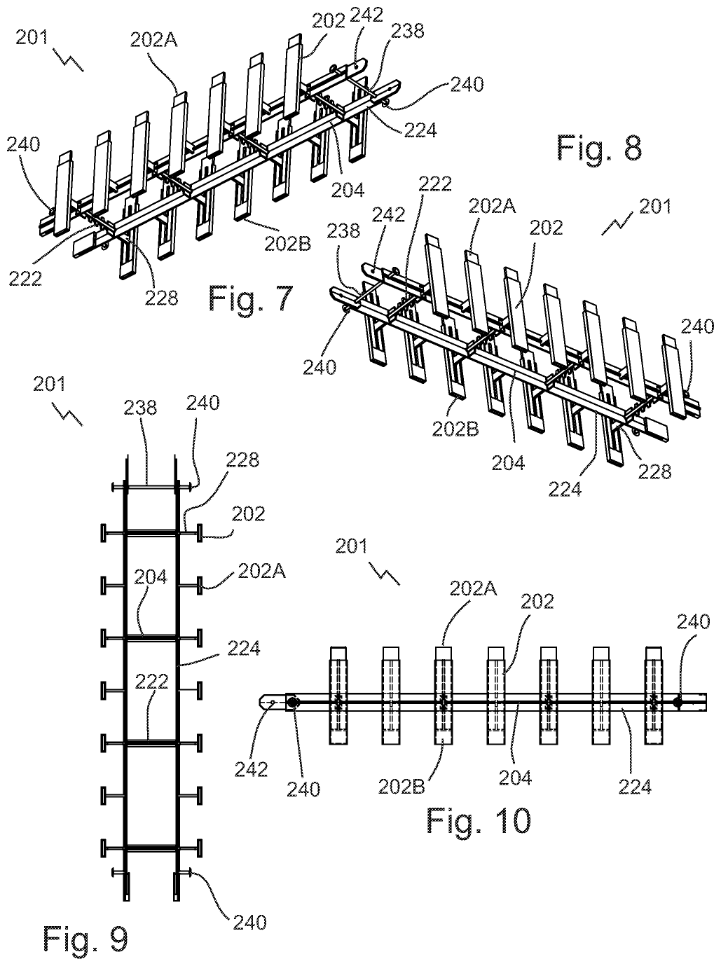

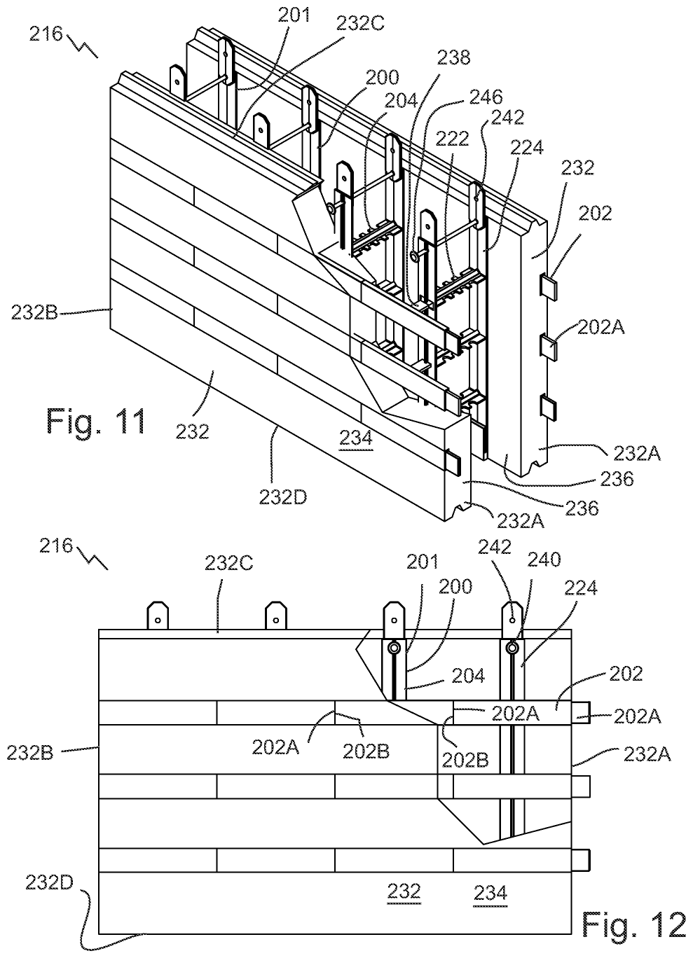

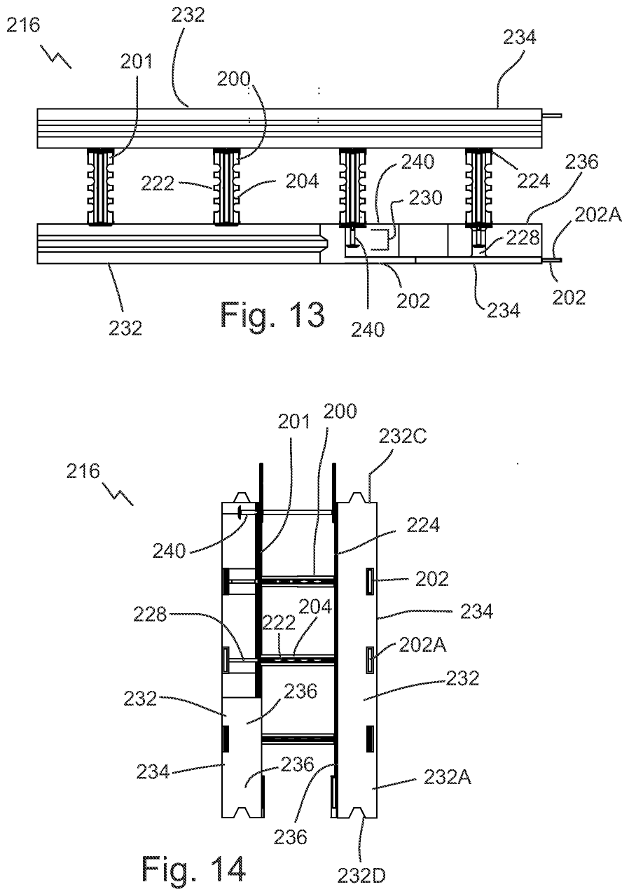

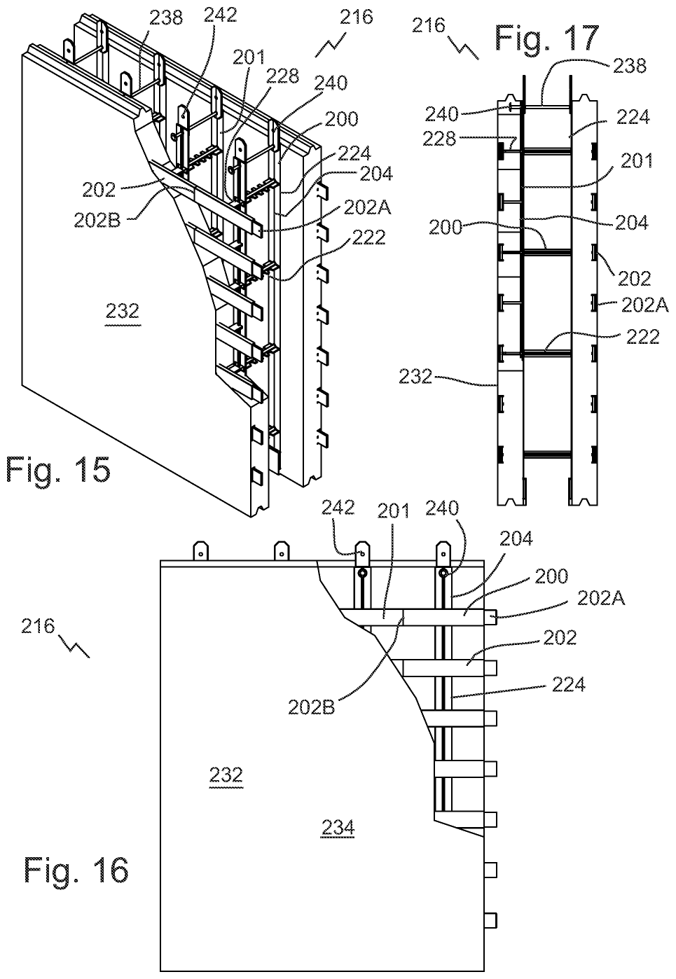

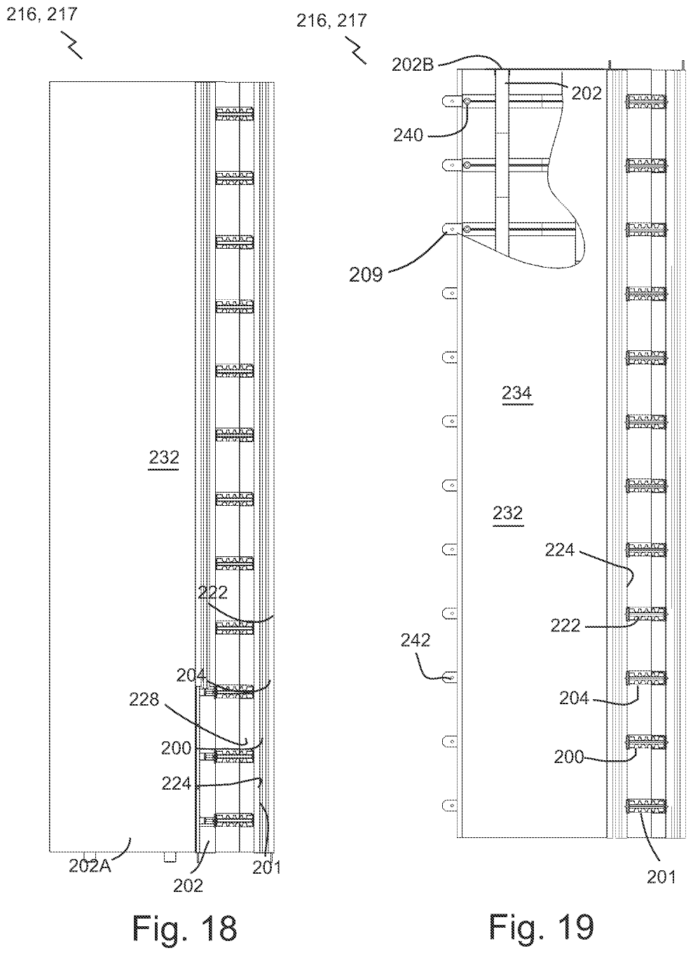

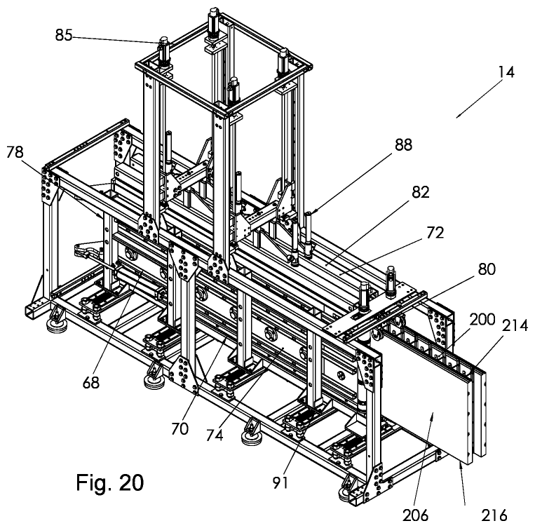

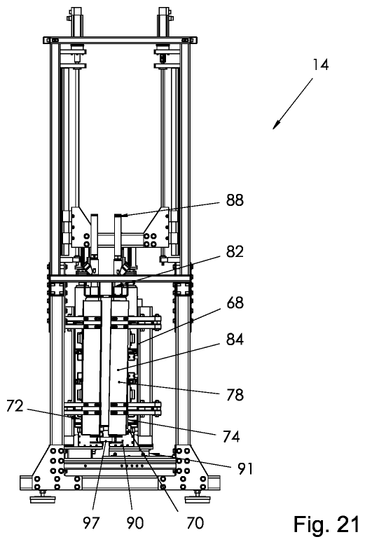

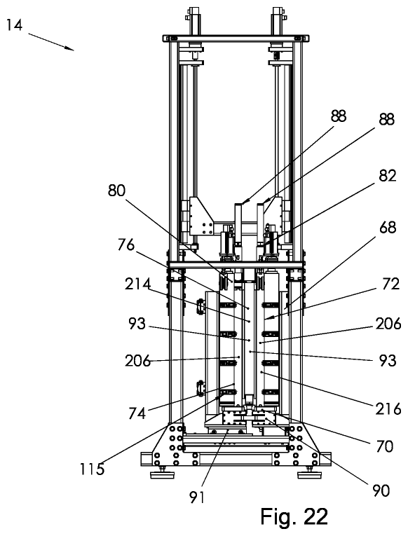

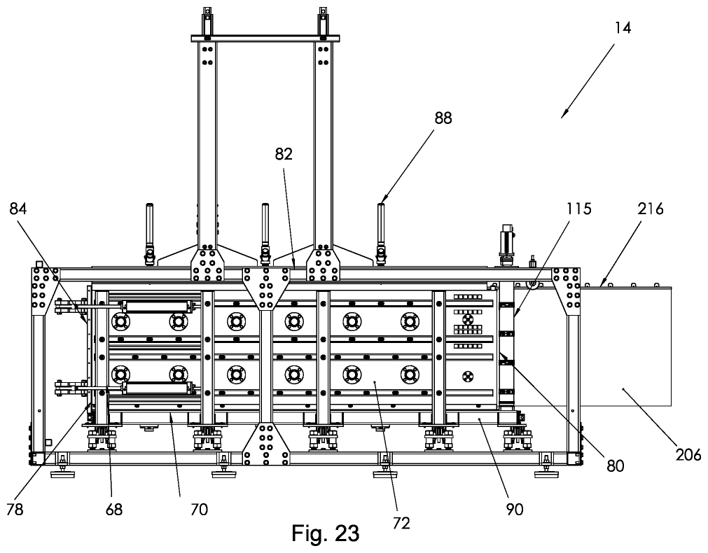

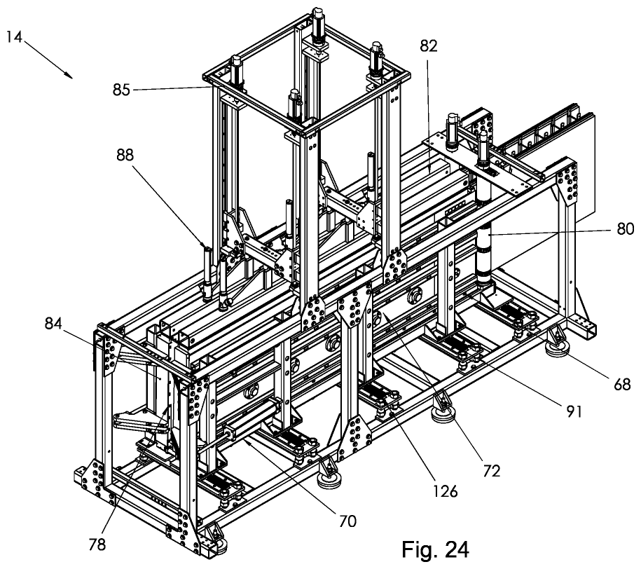

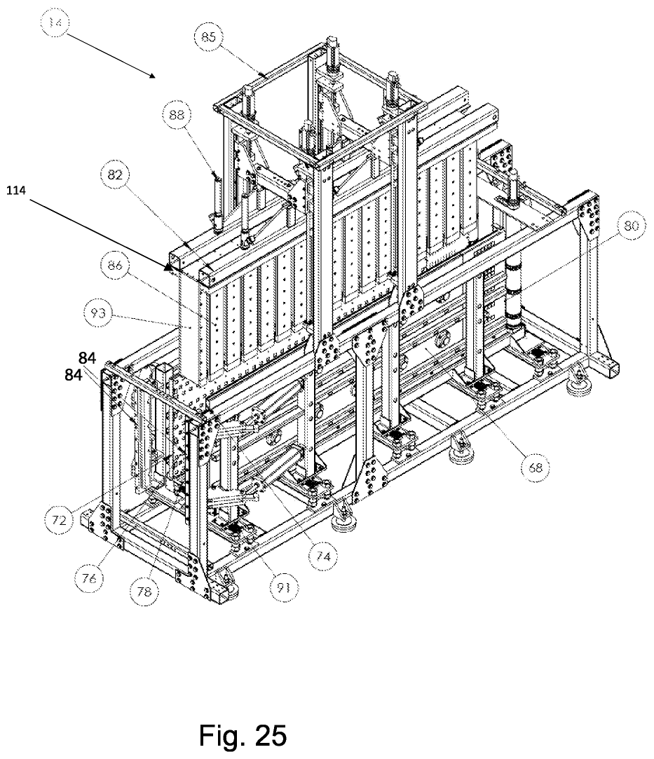

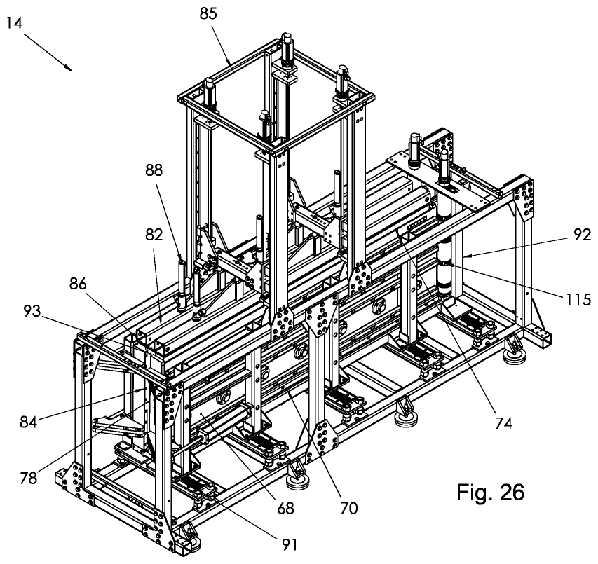

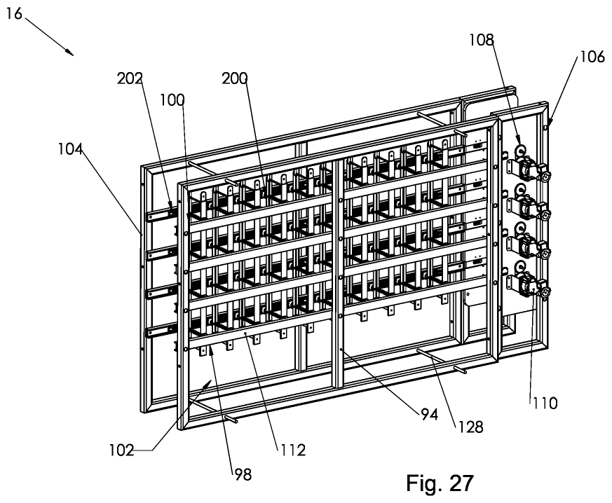

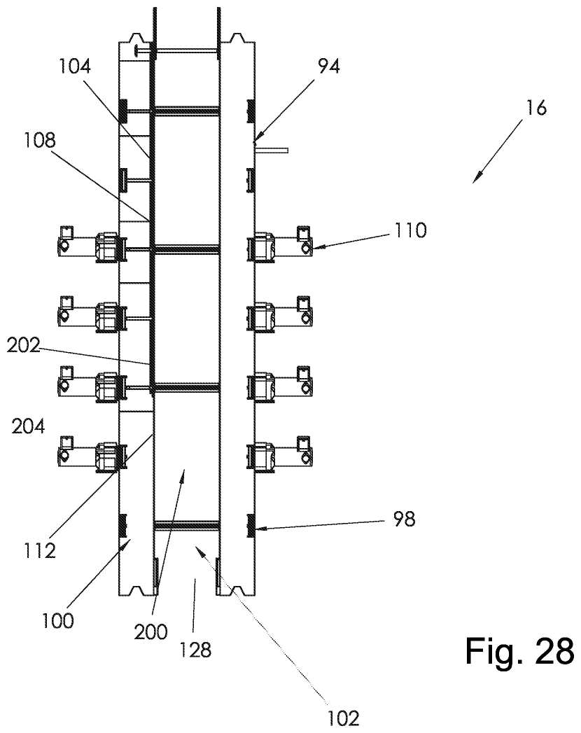

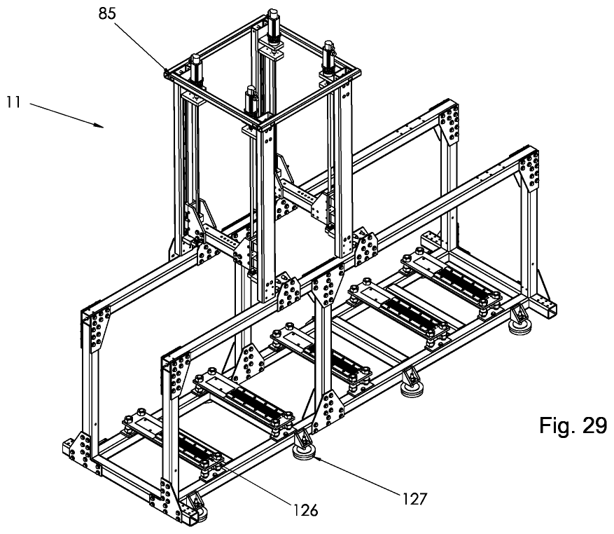

Referring to FIG. 1B, a system 10 is illustrated for constructing monolithic insulated concrete forms. The system 10 may incorporate an assembly machine 320 where skeleton frame modules 201 are connected together to form insulated concrete form skeleton frames 200. A mold assembly 14 may be present in which a foam material is molded onto the insulated concrete form skeleton frames 200. A staging area between the form assembly machine and mold assembly 14 may be provided for guiding insulated concrete form skeleton frames 200 from the form assembly machine to mold assembly 14 and connecting insulated concrete form skeletons together. A corner-making assembly 220 may be provided to convert a straight wall form into a corner form. The assembly 220 may include a cutting structure 246 and a folding structure 250.

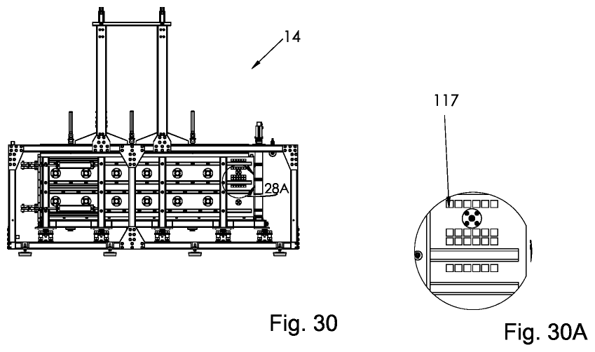

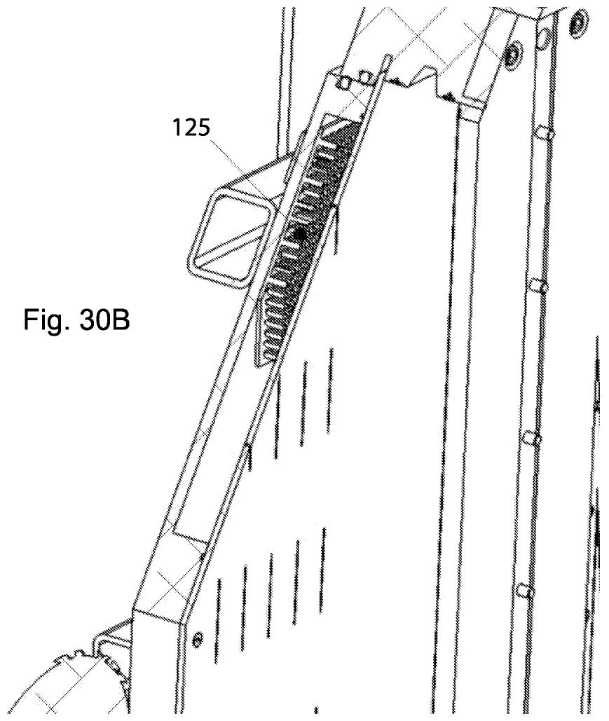

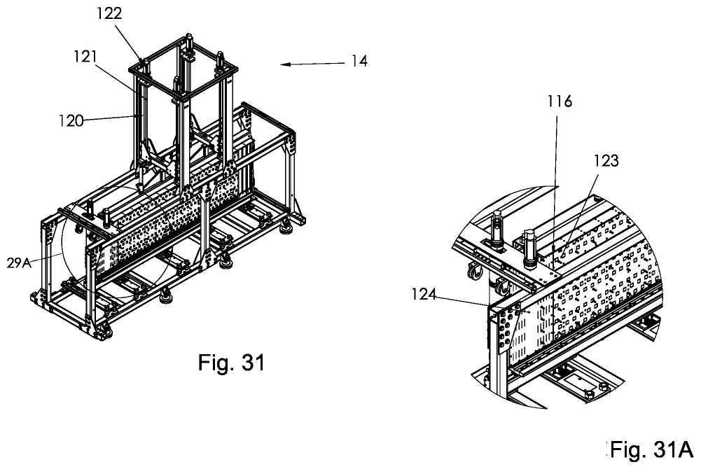

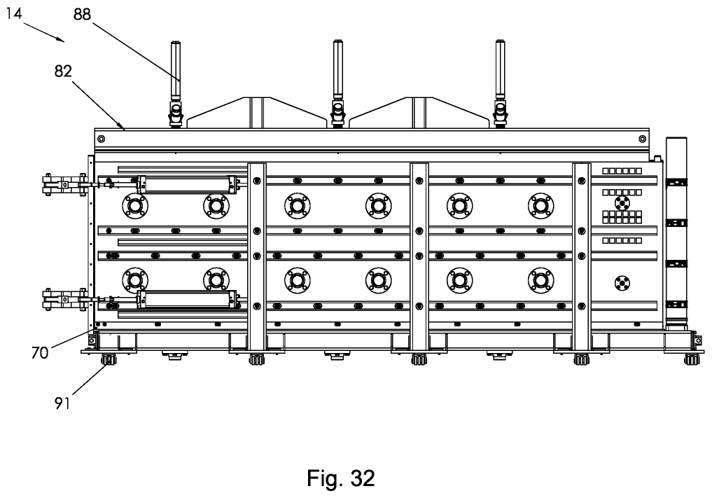

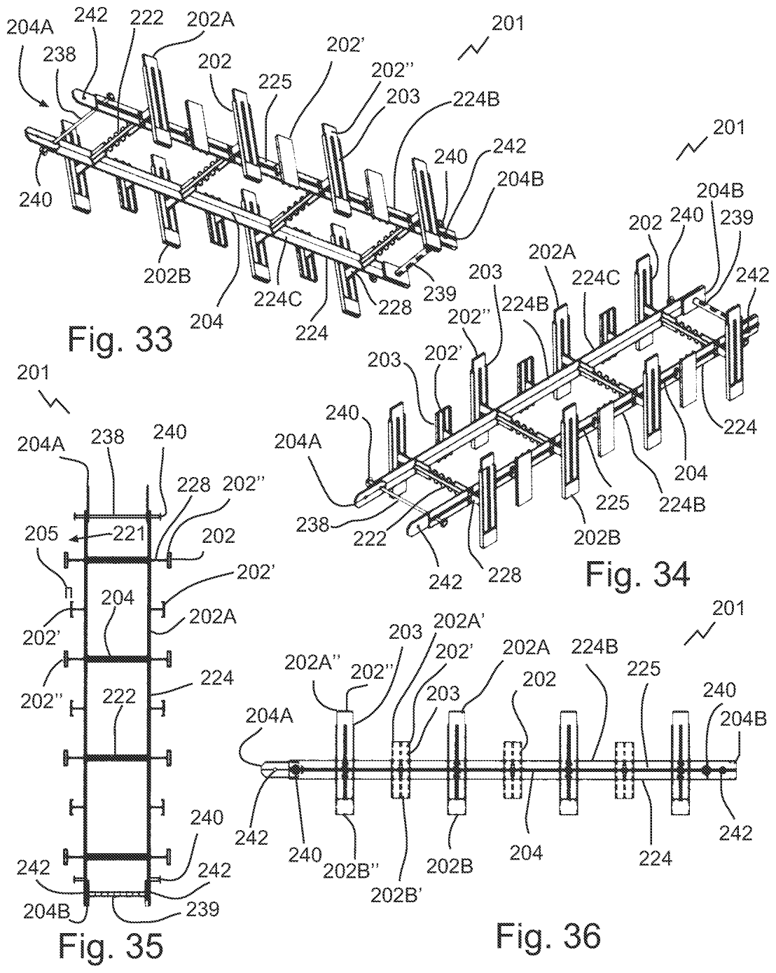

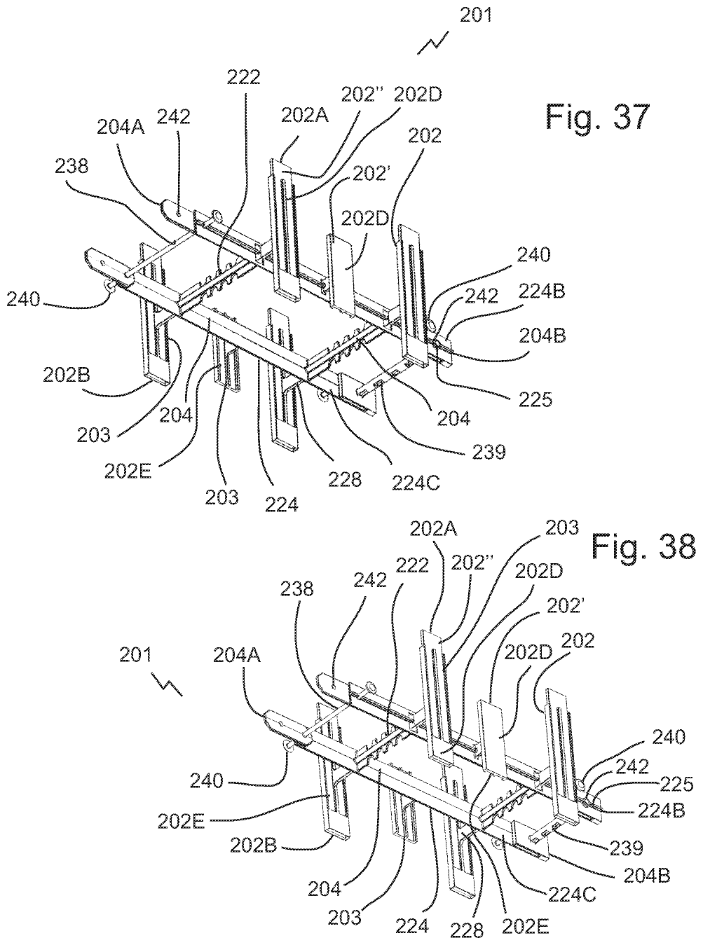

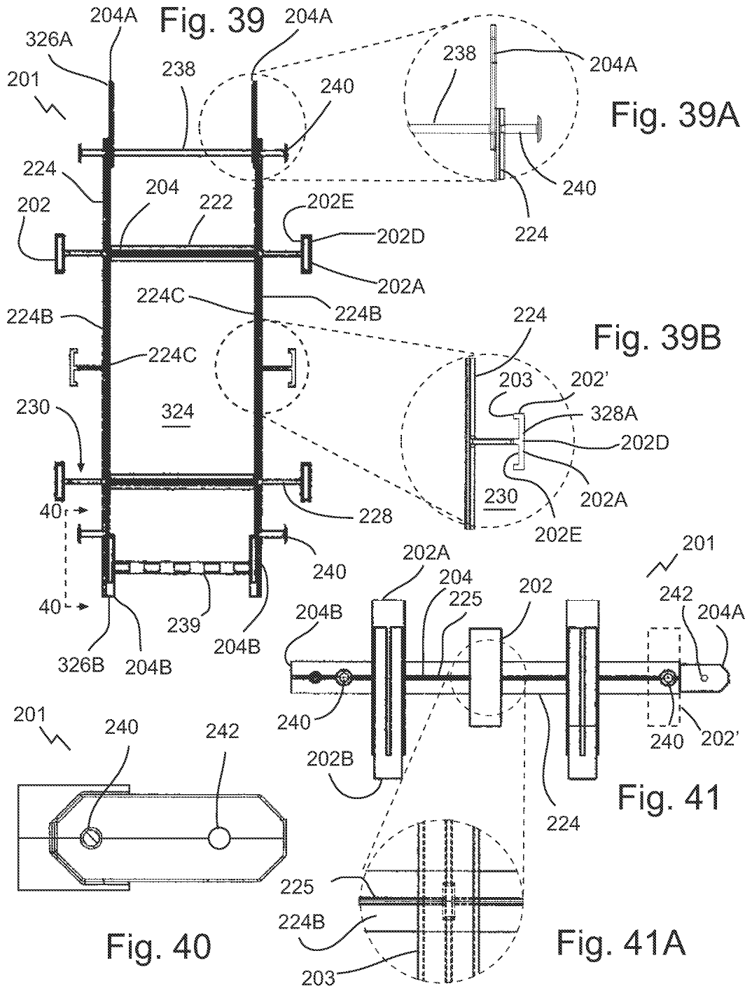

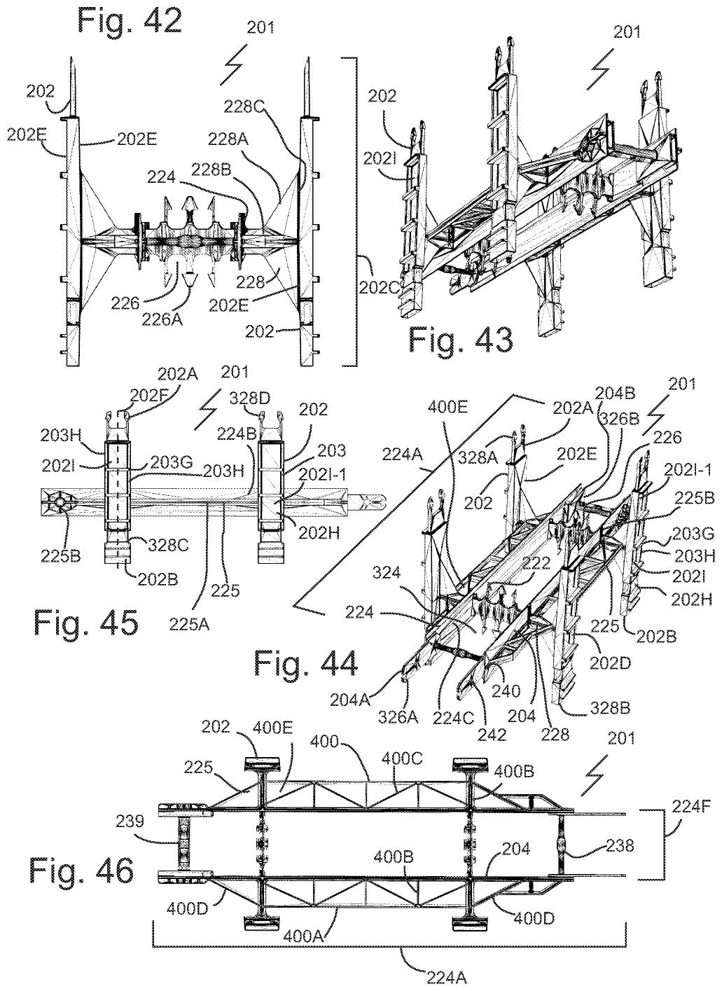

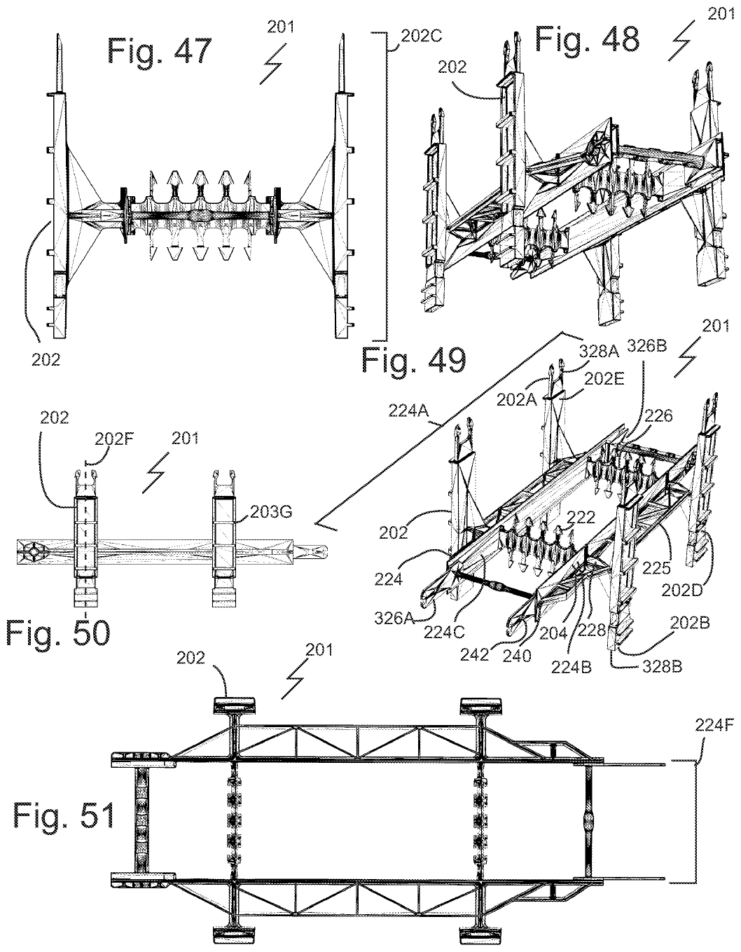

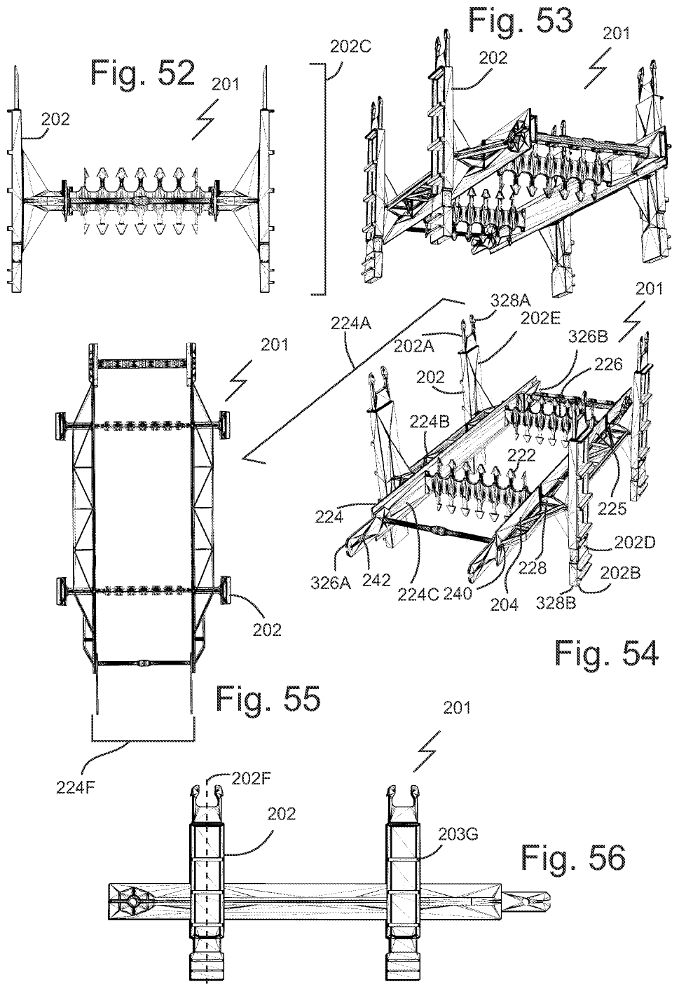

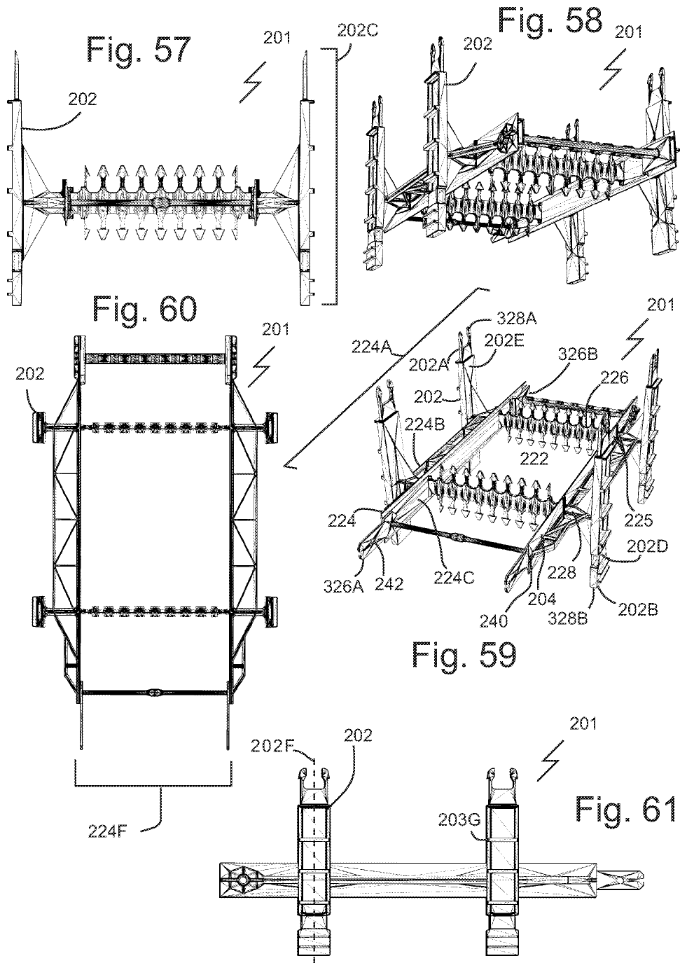

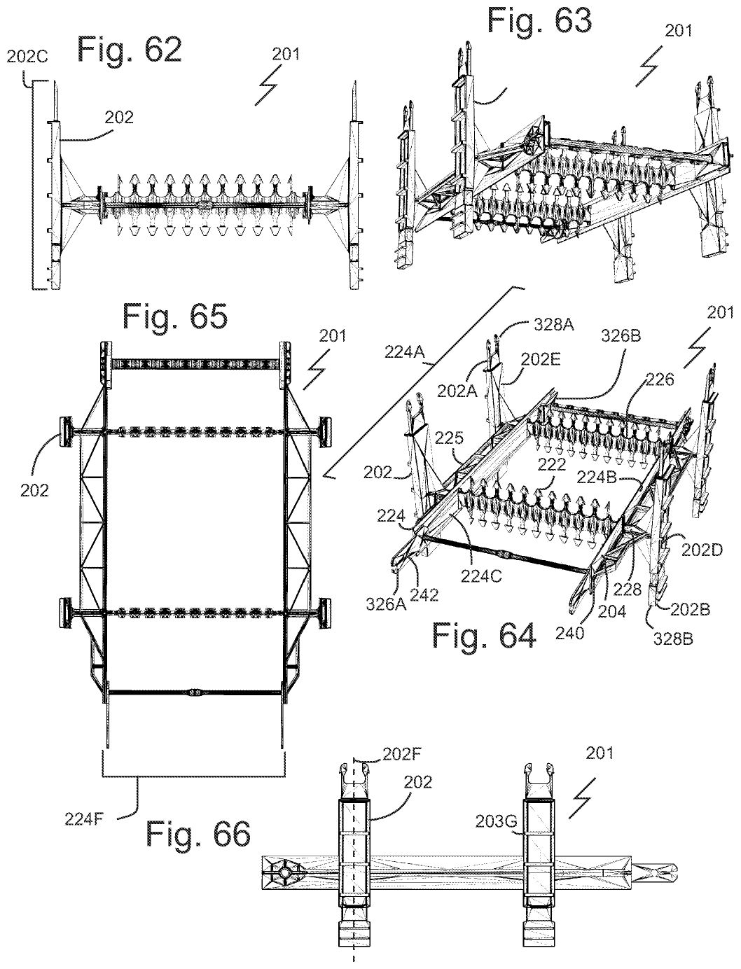

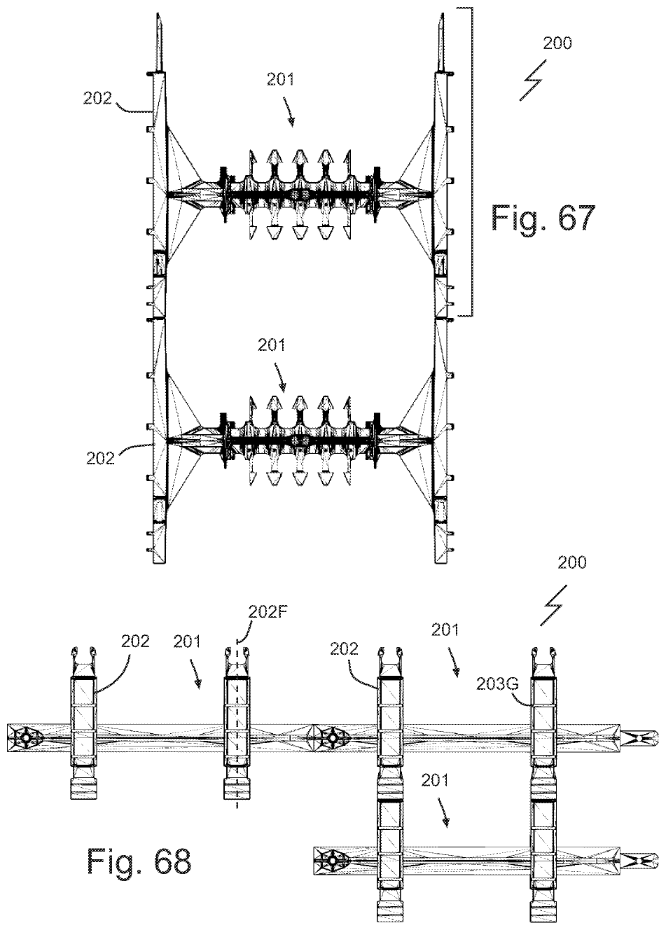

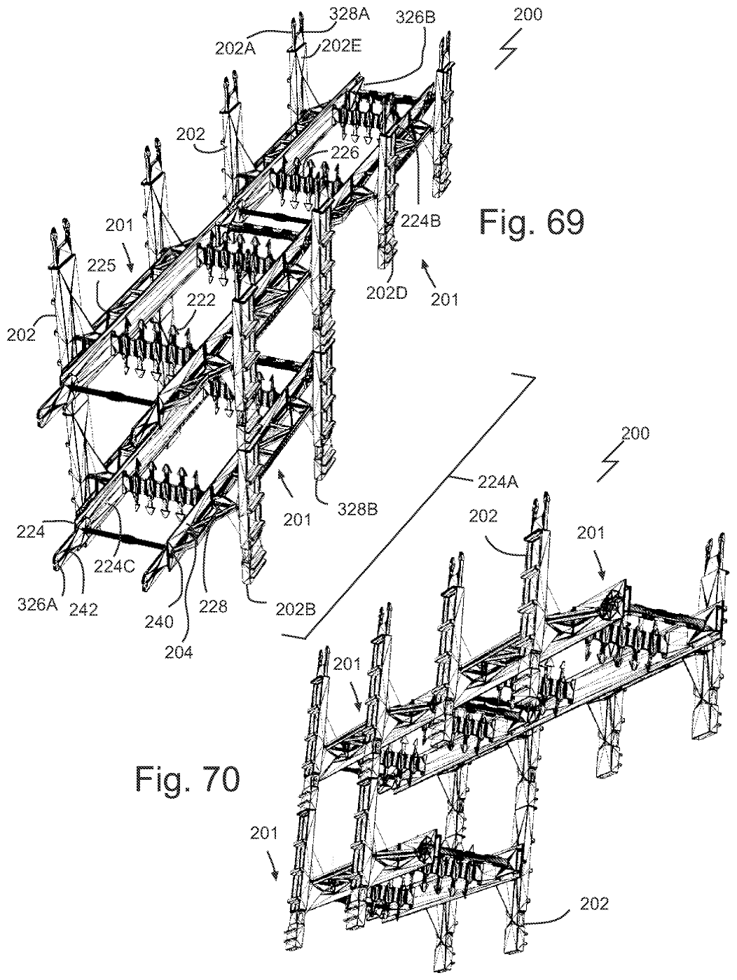

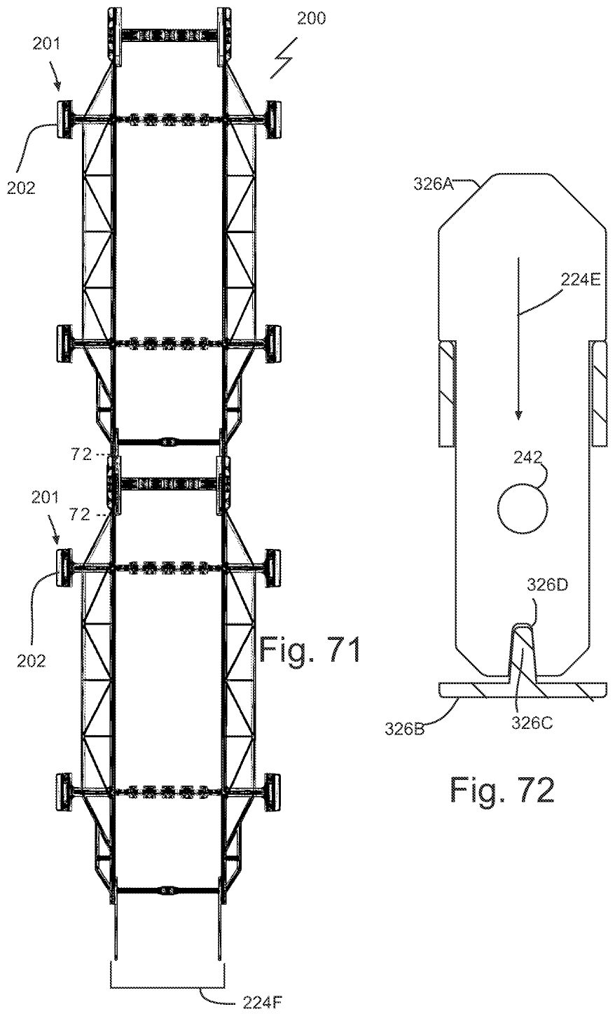

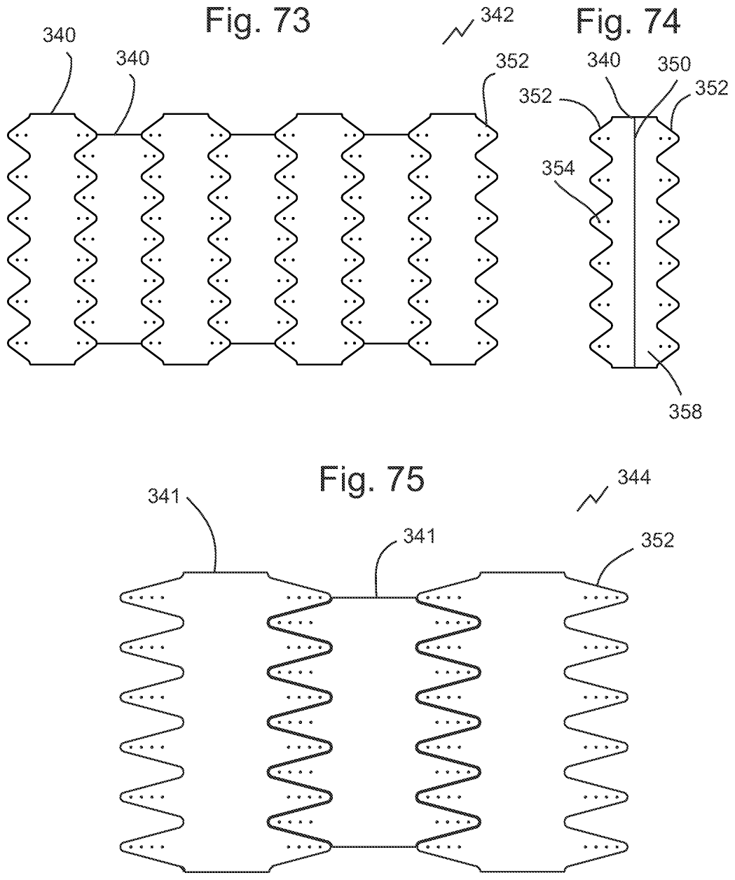

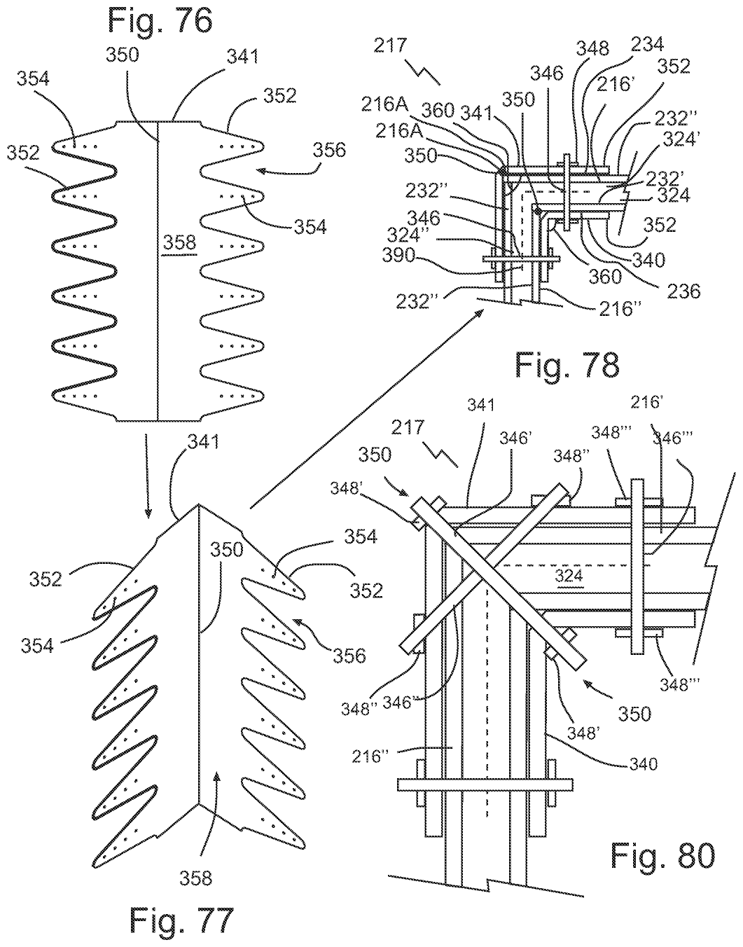

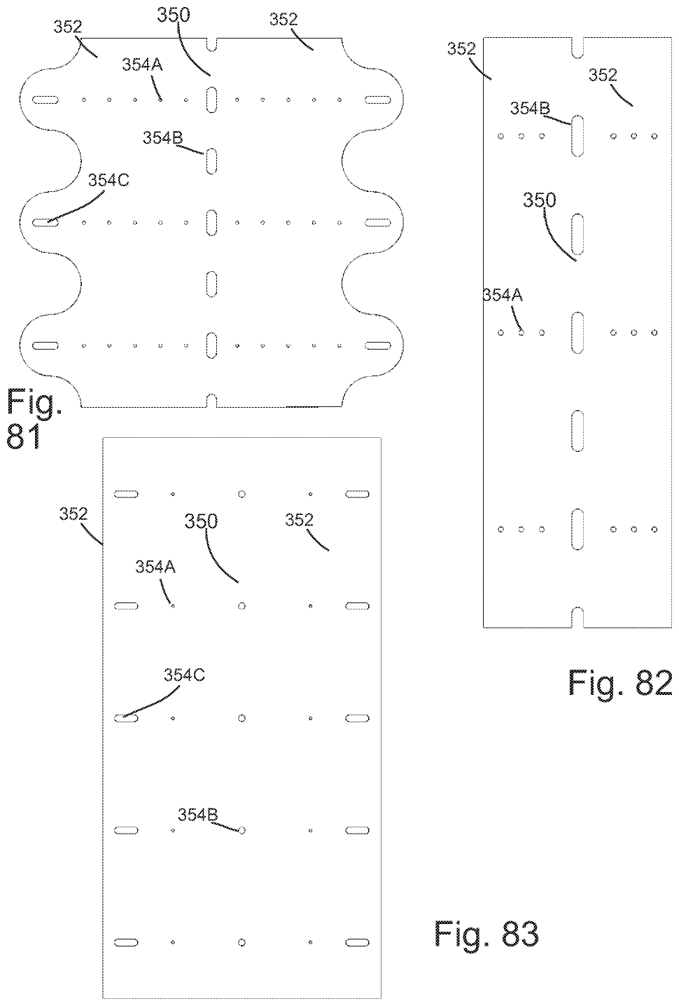

Referring to FIGS. 1-6, a concrete form skeleton frame module 201 is disclosed. The module 201 may have a ladder 204 and a plurality of studs 202. The ladder 204 may be formed of opposed side beams 224 laterally spaced from one another by a plurality of bridge beams 222. Referring to FIGS. 3 and 4, the plurality of studs 202 may be arrayed and spaced from one another along a longitudinal length 224A of exterior sides 224B of the opposed side beams 224 of the ladder 204. The interior sides 224C of the side beams 224 may face each and define a form cavity 324. The longitudinal length 224A may be defined between first and second ladder ends 204A and 204B of the ladder 204. Each of the first and second ladder ends 204A and 204B may have a ladder connector, such as connectors 326A, 326B at ends 204A, 204B, respectively, that permits connection with respective ladder connectors of adjacent modules 201 to permit the adjacent modules 201 to be secured together to form a larger form 216 (FIG. 1B). Each of the studs 202 may have a suitable height 202C, defined between top and base (first and second) stud ends 202A and 202B, respectively. Each of the first and second stud ends 202A and 202B may have a stud connector, such as connectors 328A, 328B at ends 202A and 202B, respectively, that permits connection with respective stud connectors of adjacent modules 201 to permit the adjacent modules 201 to be secured together to form a larger form 216 (FIG. 1B).

Referring to FIG. 1, the concrete form skeleton frame module 201 may be integrally formed as a monolithic unit. Referring to FIGS. 1 and 1A, the concrete form skeleton frame module 201 may be integrally molded as a monolithic unit, for example within a mold 322 (FIG. 1A). By molding the concrete form skeleton frame module 201 integrally together, for example with studs 202 integrally molded with ladders 204 in a single, integral, monolithic unit, the resulting modules 201 may be assembled end to end and/or top to bottom to build a form 216 from a matrix of any number of modules 201. The mold 322 used may be a complex mold, with removable parts that are inserted within an interior cavity of the mold 322 to define the inverse of the structure of the module 201. An integral molding method may be advantageous over a multi-part module assembled post-molding, as few molds are required, and no machine is required to assemble a single module, despite an increase in the complexity of the single mold used to make the module 201 when compared to a conventional ladder mold. Making the module 201 integrally may reduce manufacturing costs relative to a two-part ladder/stud system by sixty five percent or more, reducing cycle and production time.

The mold 322 may be a suitable mold, such as an injection mold, in which thermoplastic or other suitable polymer is injected to form the module 201. Injection molding is a manufacturing process for producing parts by injecting molten material into a mold. Injection molding may be performed with a host of materials mainly including metals, glasses, elastomers, confections, and most commonly thermoplastic and thermosetting polymers. Material for the part may be fed into a heated barrel, mixed (using a helical shaped screw), and injected into a mold cavity, where it cools and hardens to the configuration of the cavity. After a product is designed, usually by an industrial designer or an engineer, molds are made by a mold-maker (or toolmaker) from metal, usually either steel or aluminum, and precision-machined to form the features of the desired part. Various inserts may be incorporated into the interior of the mold as needed for the complex structure of the form module 201. Modules 201 may be formed by other than molding in some cases, such as by three-dimensional printing. In some cases, the mold 322 may be adjustable, for example to vary one or more of the number of studs, the number of bridge beams, the separation of adjacent studs on the same side, the separation of studs on opposed sides, the separation of bridge beams, the separation of side beams, the height of studs, the length of side beams, the width of the panels 232, and the alignment or lack thereof between studs and bridge beams.

Referring to FIGS. 1-6, the ladders 204 may have a suitable structure and orientation. In the example shown the ladders 204 comprise side beams 224 and bridge beams 222. The beams 222 and 224 may have a suitable shape, such as that of planar slats or straps as shown. The beams 222 and 224 may be resilient or rigid to provide strength to the resulting concrete wall. Referring to FIG. 6, the plurality of bridge beams 222 may define rebar slots 226 in a top edge (and or bottom edge as shown) of each bridge beam 222. Referring to FIGS. 1-6, each ladder 204 may form a mesh structure of beams and cross-beams. In the example shown the network is oriented horizontally in use, although the ladder 204 may assume other orientations. Referring to FIGS. 33-41, the ladder 204 may be reinforced, for example using longitudinal ridges 225.

Referring to FIGS. 1-6, each ladder end 204A and 204B may incorporate a suitable ladder connector 326A and 326B, respectively. The ladder connectors 326A, 326B of the first and second ladder ends may be adapted to mechanically connect to ladder connectors 326B, 326A of second and first ladder ends, respectively, of a ladder of a second concrete form skeleton frame module, which is identical to the concrete form skeleton frame module 201. Connections may be made when the second concrete form skeleton frame module is positioned in use adjacent the concrete form skeleton frame module 201 such that the first or second ladder ends 204A or 204B of the concrete form skeleton frame module 201 abut the second or first ladder ends 204B, 204A, respectively, of the second concrete form skeleton frame module.

Referring to FIGS. 1-6, suitable connectors may be used. The ladder connectors 326A, 326B, may be male connectors and female connectors, respectively. The first, second, or first and second ladder ends 204A, 204B, respectively, in this case end 204A, may comprise apertures, such as apertures 242, to permit a fastener (not shown) to pass through to secure the concrete form skeleton frame 200 and the second concrete form skeleton frame module together. Thus, in the example shown, if a female connector 326B is mounted over a male connector 326A, a fastener (not shown) may then be driven through the female connector 326B through the aperture 242, securing the connectors in place. In another case, apertures may be provided in both connectors 326A and 326B to align and permit a fastener, such as a bolt or pin, to be passed therethrough. A stabilizer, such as a stabilizer bar 238, may extend between opposed side beams 224. A stabilizer bar 238 may provide additional rigidity or strength to the structure of ladder 204. Referring to FIGS. 33-41, a guide tube 239 may be provided, for example to extend between opposed side beams 224 at one or both of ladder ends 224A or 224B to receive a bolt or pin that secures adjacent ladders together. In the example shown the guide tube 239 communicates with apertures 242. The ladder connectors may be irreleasable connectors, such as friction fit, snap fit, latching, or other one-way connectors.

Referring to FIGS. 1-6, the studs 202 may have a suitable structure and orientation. The studs 202 may have a suitable shape, such as that of rectangular planks or slats as shown, having exterior and interior sides 202D and 202E, respectively. The studs 202 may be resilient or rigid to provide strength to the resulting concrete wall. The studs 202 may be connected to the side beams 224 via a suitable fashion, such as via a plurality of lateral stems 228 that extend from the exterior sides 224B of the opposed side beams 224 to interior sides 202E of the plurality of studs 202. The stems 228 may separate the interior sides 202E of the plurality of studs 202 from the opposed side beams 224 to define opposed insulated form panel gaps 221 therebetween (discussed further elsewhere). The studs 202 may be oriented vertically in use, although the studs 202 may assume other orientations. The studs 202 may be perpendicular to the ladders 204. The studs 202 may mount to the ladders 204 at suitable points, such as on exterior sides 224B at points opposite the projection of bridge beams 222 from interior sides 224C, such that stems 228 and beams 222 form continuous rigid brace structures between opposed studs 202 on either side of the ladder 204, increasing rigidity and improving the strength and function of the studs 202 as mounting points for drywall and other suitable internal and external wall coverings.

Referring to FIGS. 1-6, the studs 202 may have other suitable characteristics. Each module 201 may have a suitable number of studs 202, such as three or more studs along each of the opposed side beams 224 of the ladder 204. Referring to FIGS. 7-10, other numbers of studs 202 may be used, such as seven or more arrayed in series along each side beam 224. Referring to FIGS. 1-6, stud separation may be adjusted as desired, for example to provide twelve, sixteen, eighteen, twenty-four, or other separation distances in inches on center (i.e. the distance between the central axis of adjacent studs). Each stud 202 may have a suitable axial height 202C, such as one foot or less, fifteen inches or less, or other suitable measurements greater or smaller. In the example shown each module 201 includes a single ladder 204 row, and hence relatively short studs 202. Referring to FIG. 1B, to avoid or minimize lateral gaps 208 between studs 202 of adjacent modules 201, studs, such as short studs 202′ may be located at or near one or both of ends 204A or 204B of ladders 204, for example at positions 209 to provide a continuous series of studs 202 spanning the modules 201 along the length of the form skeleton 200. Referring to FIG. 41, an example of a stud 202′ located at an end 204A of ladder 204 is illustrated in dashed lines.

Referring to FIGS. 33-41, the structure and/or shape of the studs 202 may be varied. In the example shown, long studs 202″ alternate with short studs 202′ along the length of the ladders. The studs 202 may be reinforced, for example by axial ridges 203. Long studs 202″ may be structured to interlock with studs 202 from modules 201 above and below the module 201, while short studs 202′ may not. Referring to FIGS. 36 and 41, the short studs 202′ may have top ends 202A and base ends 202B or one of them shorter or shallower, respectively, than the top ends 202A and base ends 202B of the long studs 202″. Referring to FIG. 35, some studs 202, such as short studs 202′, may be inset within a plane defined by the exterior sides 202D of the regular or long studs 202″, thus defining a lateral gap 205 between the plane and the exterior side 202D of the short studs 202′. The short studs 202′ may be provided to provide anchor points for hanging drywall, or for other purposes, such as reducing material demands and costs. The studs 202′ that are inset may be inset and embedded within the insulated panels 232 so that the exterior sides 202D are not visible on the exterior face of each panel 232. The shape, number, separation, and other aspects of the studs 202, ladders 204, and other features such as the presence or lack thereof of guide tubes, may be adjusted by adding or removing inserts (not shown) in a mold 322 for module 201.

Referring to FIGS. 1-6, each stud end 202A and 202B may incorporate a suitable stud connector 328A and 328B, respectively. The stud connectors 328A, 328B of the first and second stud ends may be adapted to mechanically connect to stud connectors 328B, 328A of second and first stud ends, respectively, of the studs 202 of another concrete form skeleton frame module, which is identical to the concrete form skeleton frame module 201. Connections may be made when the other concrete form skeleton frame module is positioned in use adjacent the concrete form skeleton frame module 201 such that the first or second stud ends 202A or 202B of the concrete form skeleton frame module 201 abut the second or first stud ends 202B, 202A, respectively, of the other concrete form skeleton frame module.

Referring to FIGS. 1-6, suitable stud connectors may be used. The stud connectors 328A, 328B, may be male connectors and female connectors, respectively. The first, second, or first and second stud ends 202A, 202B, respectively, may comprise apertures (not shown) to permit a fastener (not shown) to pass through to secure the concrete form skeleton frame module 201 and the other concrete form skeleton frame module together. In other cases, no apertures are present, and in such a case the two connectors may still be fastened, for example by driving a fastener such as a screw through both connectors when mated. The stud connectors may be irreleasable connectors, such as friction fit, snap fit, latching, or other one-way connectors.

Referring to FIG. 1A, a plurality of concrete form skeleton frame modules 201 may be connected together to form a concrete form skeleton frame 200. Connections may be made via connections between cooperating ladder connectors 326A, 326B, or stud connectors 328A, 328B, of adjacent concrete form skeleton frame modules 201 of the concrete form skeleton frame 200. As shown a form-making assembly 320 may be provided to facilitate or automatically connect and assemble plural modules 201, for example by feeding modules 201 into a fitting machine. A skeleton frame 200 of a desired dimension may be outputted, and sent downstream for further processing, such as attachment of plural insulated form panels 232. In some cases, the form 216 may be partially or entirely manually formed, for example by a user manually stacking and connecting plural modules 201 into the skeleton frame 200 of desired dimensions.

Referring to FIG. 1A, in the example shown, further processing includes molding of opposed insulated form panels 232 to each side of the skeleton frame 200, for example using a mold assembly 14. Operation of a mold assembly 14 is described elsewhere in detail in this document. Referring to FIGS. 11-14, an example is shown where a skeleton frame 200, made up of four stacked module frames 200 with three studs 202 per side beam 224 of ladder 204, is illustrated, with opposed insulated form panels 232 molded to the skeleton frame 200. Each of the opposed insulated form panels 232 may have exterior and interior faces 234, 236, respectively. Interior faces 236 may be mounted to the ladder 204 and spaced apart from one another to form an insulated concrete form 216. Insulating panels 232 may be mounted, for example molded, to the skeleton frame module 201 if only one module 201 is provided, or to form 216 if plural modules 201 are connected. Panels 232 may be mounted by other mechanisms, such as by fasteners or other connectors, instead of molding. Panels 232 may be three dimensionally printed in some cases, for example printed in place on skeleton frame 200.

Referring to FIGS. 11-14, each form 216 may have suitable characteristics. The insulated form panels 232 may be made of a suitable material, such as expandable polymer material, for example expanded polystyrene (EPS) foam. Suitable polymer may have a closed cell form. Polyurethane or polyurea may be used in some cases, including in examples where a two-part mixture is used to create the polymer. The plurality of studs 202 and the opposed side beams 224 may be embedded within the opposed insulated form panels 232. Referring to FIG. 13, in some cases the panels 232 are mounted within the panel gaps 230 defined between the studs 202 and the side beams 224. After molding or otherwise mounting of panels 232 on skeleton frame 200, post-panel processing may be carried out on form 216, such as cutting the insulated concrete form 216 to length and/or height. In some cases, the studs 202 or ladders 204 are trimmed to produce a flush edge at a desired dimension. In some cases, only the studs 202 are trimmed, for example ends 202A and in further cases a top part of panels 232, may be trimmed to produce a flush top edge and a form of a desired height, while still allowing plural forms 200 to be connected laterally via ladder connections to create a wall length of any desired dimension. Referring to FIGS. 15-17, a form 216 of any size may be produced, for example a form of four modules 201 with seven studs 202 per side beam 224 is illustrated.

Referring to FIGS. 18-19 an insulated concrete corner form 217 may be manufactured and/or used. The corner form 217 may have a concrete form skeleton frame 200, and opposed insulated form panels 232. Each panel 232 may have exterior and interior faces 234 and 236, respectively, with the interior faces 236 mounted to opposed sides of the concrete form skeleton frame 200 and spaced apart to define a concrete receiving cavity 324 therebetween. The concrete form skeleton frame 200 and opposed insulated form panels 232 may be folded, or connected, and secured into a corner configuration as shown, for example a ninety-degree corner as shown, although any other angular orientation from zero to three hundred and sixty degrees may be used, including curved or complex shapes.

The panels 232 may be molded onto the frames 200 in a suitable fashion. Referring to FIG. 23 and FIG. 24, mold assembly 14 may be used to mold foam material 206 onto an insulated concrete form skeleton frame 200. Referring to FIG. 22, mold assembly 14 may have an outer housing 68 and a bottom support base 70, a first side wall 72 and a second adjustable side wall 74 which define an interior cavity 76, and mold assembly 14 may be supported by a main framing 11. Referring to FIG. 31, the outer housing 68 may have an entrance 78 for access 10 to the interior cavity 76 and, referring to FIG. 32, the outer housing 68 may have an exit 80 for access to the interior cavity 76. Two independent lids 82 may be sized to seal the interior cavity 76 of the outer housing 68. In other cases, one lid is used. The lids 82 may be movable between an open position, shown in FIG. 25, and a closed position, shown in FIG. 24. Referring to FIG. 25, in the open position, access to the interior cavity 76 may be provided through the entrance 78 and exit 80 of the outer housing 68. Referring to FIG. 24, in the closed position, access to the interior cavity 76 may be limited. Referring to FIG. 24, the outer housing 68 may have two sealing door mechanisms 84 to seal the entrance 78 of the outer housing 68 when the lids 82 are in the closed position. In other cases, one door is used.

Referring to FIG. 25 and FIG. 26, first and second pluralities of downward oriented extensions 86 may be movable between a retracted position (open position) and an inserted position (closed position). The first and second pluralities of downward oriented extensions 86 are in the inserted position, first and second mold cavities are defined by the first and second mold lids, the first and second entrance door mechanisms 84, the first and second pluralities of downward oriented extensions 86, and the insulated concrete form skeleton frame (with the extensions and skeleton frame contacting one another in use to define respective inside walls of the mold cavities so that a seal is formed around the top, bottom, ends, and inside and outside walls of each mold cavity to permit insulating material to fill the mold cavities and form the requisite insulating panels on the skeleton frame). In the example shown the extensions 86 may protrude from the lids 82. The extensions 86 may be connected to a mounting block 114. The downward oriented extension 86 may be positioned such that they may allow for the creation of form respective insulating panel forming mold cavities such as voids 214, shown in FIG. 20, in the molded insulated concrete form 216, shown in FIG. 20. The downward oriented extensions 86 may be positioned within an interior of the insulated concrete form skeleton frame 200 between the studs 202 positioned on either side of the stud receiving ladders 204.

The first and second pluralities of downward oriented extensions 86 may be inserted into a series of spaces, for example vertical spaces, defined by and along opposed sides of an insulated concrete form skeleton frame that is located within the interior cavity in use. The inserted or descending extensions may align into the connected pluralities/skeleton frame to create the mold cavity. Once molded/formed the extensions may be retracted to release the molded monolithic form. Entrance and exit rollers and drive wheels, may push and pull (extract) the molded form. This extraction process connects the pre-staged attached/connected skeleton frame/pluralities to the previous molded skeleton frame/pluralities creating a monolithic continuous molded ICF form. When foam is injected into the mold assembly 14, it may not enter the area between the studs 202 positioned on either side of the stud receiving ladders 204 as these areas are blocked by the downward oriented extensions 86 which are supported by spacer plates 93 which also help reduce chances of buckling, shown in FIG. 22. Each opposite group of extensions 86 may be supported by a spacer such as a spacer plate 93. Referring to FIG. 25, FIG. 24, and FIG. 31, the lids 82 may be movable between the open position, and closed position, through the use of the lifting system 85. The lifting system 85 may use heavy-duty linear guides 120, ball-screws 121, and motors 122 to lift the lids 82 into and out of position efficiently, at a set desired acceleration and speed, and may help to ensure that lids are properly aligned with the outer housing 68 and the bottom support base 70 and insulated concrete form skeleton frame 200 each time the lids 82 are moved. This, in turn, may prevent damage to the insulated concrete form skeleton frame 200 and consistent insulated concrete forms 216 being made. A person of skill will understand that different methods of moving the lids 82 upwards and downwards may be used including manually lifting and lowering the lid, hydraulics, the use of machinery such as a crane, pneumatics, and any other method known in the art. In some cases, legs (extensions 86) may come from the top and bottom of the respective mold cavities. In some cases, the extensions move independently of the lids.

Referring to FIG. 24, at least one fill gun 88 may be provided for the injection of foam beads or other suitable material into the interior cavity 76 of the mold assembly 14. A person of skill will understand that fill guns 88 may be positioned anywhere on mold assembly 14 as long as they are capable of injecting foam beads or other suitable material into the interior cavity 76. In one embodiment, a plurality of fill guns 88 are positioned on the lids 82. This orientation of fill guns 88 allows for more uniform injection of foam beads or other suitable material into the mold assembly 14. Referring to FIG. 23, a steam inlet/drain 90 and steam inlet 123 may be provided for the injection of steam into the interior cavity 76. The steam causes activation of the foam beads that are injected into the interior cavity 76 using fill guns 88. Referring to FIG. 26, high temperature rubber block plugs 92 may be provided. The high temperature plugs 92 seal the exit 80 of the outer housing 68 and may be used once while the lids 82 are closed for the first insulated concrete form 216. Referring to FIG. 26, when used in the creation of a monolithic insulated concrete form, the high temperature plugs 92 may be used to seal the exit 80 of the outer housing 68 during molding of the first insulated concrete form portion 216a. Once this portion 216a has been molded, it may be pushed mostly out of the mold assembly 14 by using a conveyor such as ejection rollers 115, shown in FIG. 23 and by the next insulated concrete form skeleton frame 200 which has been connected to it. Referring to FIG. 23, the first insulated concrete form portion 216a remains blocking the exit 80 while the next insulated concrete form skeleton frame 200 is molded. Once the first insulated concrete form 216 is molded, the blocking part such as the high temperature rubber plugs 92 may be removed. Referring to FIG. 31, a high temperature sealing mat 116 may be placed in-between the steam inlet 123 and the cold air injection system 124. The high temperature sealing mat 116 separates the hot and cold sides from the insulated concrete form 216. The cold air injection system 124 cools down the insulated concrete form 216 to stop further growth of the expanded polystyrene and maintain its shape. Referring to FIGS. 30, 30A, and 30B, the cold air injection system 124 may use a thermoelectric cooler 117 and aluminum fins 125. A person of skill will understand that different methods of cooling the insulated concrete form 216 may be used including direct air, coolers, pressurized air, and any other method known. Referring to FIG. 26, As the insulated concrete form 216 is ejected by the ejection rollers 115, a product label may be debossed on the surface of the insulated concrete form 216.

Referring to FIG. 21, in the embodiment shown, mold assembly 14 may have bottom rollers 91 with removable spacer plates 93 and removable bottom spacers 97. By using removable spacer plates 93, the user may mold different sizes of cores of insulated concrete forms 216 by simply switching out the spacer plates 93 and bottom spacers 97. It also allows for the spacer plates 93 to be replaced as they wear, without the requirement to obtain an entirely new mold assembly 14.

Referring to FIG. 29, the mold assembly 14 may have two sides. One side may be fixed to the mold assembly framing 11, while the other moving adjustable side may have bottom rollers 91 that may be placed on top of the linear guides 126 of the mold assembly framing 11. The mold assembly framing 11 may be supported by heavy duty leg stands 127. The lifting system 85 may be attached to the mold assembly framing 11. Mold assembly 14 and lifting system 85 may be supported by the mold assembly framing 11.

Referring to FIG. 27 and FIG. 28, staging area 16 may have a support structure 94 that has an adjustable shaft 128, a first wall 98 and a second wall 100 which define a staging channel 102 and both walls may be disconnected and re-assembled to adjust for other sizes of insulated concrete form skeleton frames 200. The staging area 16 may be adjustable and may move along shafts 128 and the staging area is fastened to the assembly 320 and mold assembly 14. Support structure 94 may have an entrance end 104 and an exit end 106 through which insulated concrete form skeleton frames 200 travel. Movement through staging area 16 may occur through contact between insulated concrete form skeleton frames 200 or through the use of driving means. Insulated concrete form skeleton frames 200 may be driven forward through the use of rams, pistons, pulleys, rollers and any other driven device known in the art. A strong enough force will cause insulated concrete form skeleton frames 200 that are positioned in end-to-end relation within staging channel 102 and mold assembly 14 to be connected. This may be completed through manual force such as where the operator applies pressure until the ends connect. It is preferable, however, for this to be an automated force. Referring to FIG. 27, in the embodiment shown, this force may be created through the use of rollers 108 powered by electric motors 110 positioned at the exit end 106 of the support structure 94. The positioning of these rollers 108 at the exit end 106 of the support structure 94 allows for the connection of the insulated concrete form skeleton frame 200 in the mold assembly 14 to the insulated concrete form skeleton frame 200 in the staging area 16.

Referring to FIG. 1B, assembly machine 320, mold assembly 14 and staging area 16 are preferably made of a metal such as steel or aluminum. A person of skill will understand that different materials may be used for different components of system 10.

Referring to FIG. 1B, system 10 is preferably a completely automated system. A control panel, not shown, may be linked to system 10 to control each aspect of the system, from the movement of modules 201 from the assembly 320 through to removing and labelling the completed insulated concrete form 216 from the mold assembly 14 using ejection rollers 115, to the formation of corner forms 217 if corner forms 217 are desired. Referring to FIG. 28, studs 202 of insulated concrete form skeleton frames 200 slide along guiding channels 112 within staging channel 102 of staging area 16. Referring to FIG. 27, electric motors 110 that control rollers 108 may be controlled by the control panel and may be used to provide the necessary force to connect the insulated concrete form skeleton frame 200 in the staging area 16 with the insulated concrete form skeleton frame 200 positioned within molding assembly 14, shown in FIG. 20. Referring to FIG. 1B, rollers 108 may also be used to propel insulated concrete form skeleton frame 200 into mold assembly 14 and push the completed insulated concrete form 216 out of exit 80 working in conjunction with the ejection rollers 115.

Referring to FIG. 25, the control panel may control the movement of the lids 82 between the open position in which an insulated concrete form skeleton frame 200 can be positioned within interior cavity 76 and a closed position, shown in FIG. 24, in which access to the interior cavity 76 may be limited. Molding of insulated concrete form 216, shown in FIG. 26, occurs when the lids 82 are in the closed position. The injection of foam beads or other suitable material through fill guns 88 and the injection of steam through steam inlet/drain 90 and steam inlet 123 may also be controlled by the control panel.

FIG. 32 the bottom support base 70 may have two fixed mounting holes and slots along the side and along the steam inlet 123. This may allow for expansion and contraction to occur without moving the fixed ends and damaging the bolts.

Referring to FIG. 27, electric motors 110 that control rollers 108 may be controlled by the control panel and may be used to provide the necessary force to connect the insulated concrete form skeleton 200 in the staging area 16 with the insulated concrete form skeleton 200 positioned within molding assembly 14, shown in FIG. 20.

Referring to FIGS. 42-46, a further embodiment of the skeleton frame module 201 is shown. The module 201 comprises a plurality of studs 202 and a ladder 204. As above, the concrete form skeleton frame module 201 may be integrally molded as a monolithic unit. Each stud 202 may be elongate, may define an axis 202F between axial ends 202A and 202B, may be of a suitable height 202C, and may have an exterior face or side 202D and an interior face or side 202E. The ladder 204 may be formed of opposed side beams 224, which may be laterally spaced from one another by a plurality of bridge beams 222. Each side beam 224 may be elongate, may define an axis 224E between axial ends (such as defining ladder ends 204A and 204B), may be of a suitable length 224A, and may have an exterior face or side 224B and an interior face or side 224C. The empty space between the opposed side beams 224 may function as a form cavity 324. One or both of the studs 202 and ladder 204 may incorporate reinforcing features, which may one or more of reduce material requirements, increase rigidity and strength, and improve aspects of installation.

Referring to FIGS. 42-46, each stud 202 may comprise reinforcing features, such as one or more reinforcing ridges 203. Reinforcing ridges may be structures that project from the body of the greater structure for a variety of purposes, such as to form a sub frame of structural members that increases rigidity and strength, and to reduce material requirements by creation of cavities. The reinforcing ridges 203 may comprise axial ridges 203H, for example parallel to an axis 202F of the stud 202. The reinforcing ridges 203 may be located on a suitable portion of the stud 202, for example on an exterior face 202D of the stud body 202H. The axial ridges 203H may be located at or near or defining a periphery of the stud 202 or face 202D of the stud 202 or a portion thereof The reinforcing ridges 203 may project from a body 202H of the stud 202. The reinforcing ridges 203 may comprise lateral or cross ridges 203G, for example perpendicular to the axis 202F of the studs 202. The reinforcing ridges 203 and stud body 202H may define foam or concrete cavities 202I. The foam cavities 202I may be bounded by reinforcing ridges 203. A base 202I-1 of each cavity 202I may be defined at least partially by the stud body 202H, for example exterior surface 202D of the stud 202. In the example shown, each stud 202 defines at least three such cavities 202I spaced along an axial length 202C of the stud 202. The cross ridges 203G and axial ridges 203H may form a lattice of structural members, for example with steps and columns, respectively. Such a structure may improve the rigidity of the stud 202, which may reduce the amount of flexure in the stud 202 when encountered by a fastener, for example used to hang dry wall against an insulative panel 232 (not shown) connected to the module 201 after manufacture and installation in a building. In use the ridges 203 may remain embedded within the foam panel 232 (not shown), such that the finishing layer or dry wall/substrate does not physically contact the ridges 203, however the ridges 203 provide backing and reduced flexure of the substrate.

Referring to FIGS. 42-46, each ladder 204, for example the opposed side beams 224 may comprise reinforcing features, such as one or more reinforcing ridges 225. The reinforcing ridges 225 may comprise one or more axial ridges 225A, for example on an exterior side 224B of the opposed side beams 224 (in other cases the ridges 225 and/or 203 may be on interior sides or both interior and exterior sides). The axial reinforcing ridges 225 may extend a suitable distance, for example a longitudinal length 224A of the opposed side beam 224. The reinforcing ridges 225 may comprise lateral or cross ridges 225B, for example perpendicular to the axis 224E of the side beams 224. The reinforcing ridges 225, for example ridges 225A, may comprise a lattice 400 of structural members. The lattice 400 may be comprised of a variety of structural members, such as peripheral members 400A, bridge members 400B, cross members 400C and outer diagonal members 400D, interconnected together. The lattice 400 may be oriented in a plane perpendicular to the exterior side 224B of the opposed side beam 224. The peripheral members 400A may extend along, for example parallel to, the side beams 224. The members 400A or other parts of the lattice 400 may connect to or incorporate lateral stems 228. Bridge members 400B may span from the exterior surface 224B of the side beam 224 to the peripheral members 400A. The cross members 400C may span from the exterior surface 224B of the side beam 224 to the peripheral members 400A. The cross members 400C may span the region at a non-right angle, while bridge members 400B may span the region perpendicular, to the side beams 224 and/or the peripheral members 400A. One or more types of members may connect at the same junction, for example cross members 400C may connect to the peripheral member 400A at the same point as the bridge member 400B. The lattice 400 may also have outer members, such as diagonal members 400D, which span between the studs 202 and the ends of the ladder 204A, 204B. The lattice 400 may provide a structure that defines foam cavities 400E. The lattice 400 or other forms of ridges 225 may improve the rigidity of the module 201, and thus the strength, while reducing material requirements. The lattice 400 may also be at least partially, for example fully, embedded in a foam panel 232 (not shown) after manufacture, thus increasing the strength of the panel 232 and reducing the risk of breakage of the panel 232 under stress.

Referring to FIGS. 42-46, each stud 202 may mount to an opposed side beam 224 via a suitable connector, such as a lateral stem 228. The lateral stem 228 may comprise a gusset 228A, of a suitable shape such as a polygon or triangle. The lateral stem 228 may be oriented such that an apex 228B of the lateral stem is adjacent to the opposed side beam 224. A long edge of the lateral stem, such as a base 228C of the gusset 228A, may be adjacent an interior face 202E of the stud 202. Members of lattice 400, such as members 400D, 400A, and 400C may connect to the stud 202 and/or stem 228, for example as shown, for increased strength and rigidity.

Referring to FIGS. 42-46, the studs 202 may have suitable connectors 328A and 328B for connection to studs 202 of other modules 201. A top stud end 202A may have a suitable connector, such as connector 328A, while a base stud end 202B may have a suitable end, such as connector 328B. Connecter 328A may be structured to irreleasably or releasably connect to the connector 328B of another module 201. The connectors 328A and 328B may comprise suitable connectors, such as those forming a buckle as shown. In a buckle embodiment, connector 328A may comprise a pair of resilient arms 328D, which may be structure to flex inwardly when pressed into the connector 328B. Connector 328B may have side cutouts 328C, which may allow the resiliant arms 328D to expand into the cutouts 328C, and thereafter be depressed to permit retraction and disconnection of the connectors 328A and 328B if so desired. A buckle fastener is one option, although there are other ways to connect studs 202 such as via shark teeth, ratchets, friction fits, interference fits, latches, and others. Adhesive or welding may be used.

Referring to FIGS. 42-46, the ladder ends may have suitable connectors 326A and 326B for connection to ladders 204 of other modules 201. A first ladder end 204A may have a suitable connector, such as connector 326A, while a second ladder end 204B may have a suitable end, such as connector 326B. Connecter 326A may be structured to irreleasably or releasably connect to the connector 326B of another module 201. The connectors 326A and 326B may comprise suitable connectors. The ladder connectors 326A and 326B may comprise a tongue and groove connection, such as via female grooves and male tongues, which is an example of a keyway and key connection. A keyway includes a slot cut in a part of a machine or an electrical connector, to ensure correct orientation with another part which is fitted with a key. Referring to FIG. 72, a female groove 326C may function as a slot. The groove 326C may connect with a male connector, such as a tongue 326D within the connector 326B. The connectors 326 may be structured to have a friction or interference fit. For example, the female groove 326 may open in a direction parallel to an axis 224E of the opposed side beams 224. The male tongue 326D may comprise a lateral shelf. One or both of the female groove and male tongue may be tapered in width in a direction toward the other of the female groove and male tongue when connected. In the example shown, the male tongue 326D tapers with decreasing width, and the female groove 326C tapers with increasing width, in the direction one toward the other. Referring to FIGS. 42-46 and 72, other connection mechanisms may be provided. For example, a guide tube 239 may be provided, for example to extend between opposed side beams 224 at one or both of ladder ends 204A or 204B. The tube 239 may be structured to receive a bolt or pin that secures adjacent ladders together. In the example shown the guide tube 239 communicates with apertures 242 at the ladder end 204B. The ladder connectors may connect by suitable mechanisms, such as via shark teeth, ratchets, friction fits, interference fits, latches, and others. Adhesive or welding may be used. In some cases the ladder ends may comprise buckles.

Referring to FIGS. 42-46, the ladders 204, for example the plurality of bridge beams 222, may define rebar connectors or mounts, such as slots 226. The slots 226 may have suitable features and may be structured to receive and position, and in some cases secure or enclose, rebar or other reinforcing parts such as mesh. Each beam 222 may have slots 226 both above and below the bridge beams 222, for example to permit rebar to mounted regardless of the orientation of the form right side up or upside down. The rebar slots 226 may comprise one-way connectors 226A, for example to receive a reinforcing member such as rebar, and to retain it from being withdrawn by a movement opposite to one that would install the member. The one-way connectors may comprise tapered tabs that may flex laterally in order to enclose the rebar within a rebar slot 226. The one-way connectors may be any suitable connectors, such as a plurality of arrowhead wedge structures 226A. Rebar may be inserted within the continuous concrete receiving cavity 324 to follow the configuration of the interior of the form. The rebar 390 may rest upon the ladders 204 of the form 217 as described elsewhere in this document. In some cases, other reinforcing materials may be used such as fibers, for example TUF-STRAND™ made by Euclid Chemical. Referring to FIGS. 42-46, the embodiment of module 201 may thus have various features. Ridges 203 may

function as ribs that reinforce to the drywall, i.e. provide reinforcement and reduced gap to the finishing layer, to reduce flex and fastener pop out from a wider gap, relative to a straight stud without ribs. The use of ridges may reduce molding material with cutouts because the overall structure requires less material to create. Stud to web connections may incorporate a gusset and brace structure, which may eliminate or reduce back and front end flexure of the assembly system. Friction fit arrowheads may be used to secure and mount rebar. The ladders and studs may form a grid system. The groove connectors 326A may form a keyway slot for bridge member ends or connectors 326B. Webbing between bridge members (side beams 224) may be gapped a suitable distance, such as at least twelve inches, which may be double or more the width of competitors or standardized gaps of six inches, thereby allowing better relative free flow of aggregate into the core with reduced occurrence of honeycombing or void formation from rocks and aggregate bunching without satisfactory matrix of concrete.

Referring to FIGS. 47-66, multiple different embodiments of the skeleton frame module 201 are shown. The embodiments may contain all the features found within the embodiment shown in FIGS. 42-47, with varying separation distances between side beams 224. Relative to the FIG. 42 embodiment, the embodiments of FIGS. 47-66 may create a larger form cavity 324. The larger cavity may be achieved by increasing the lateral distance 224F between the opposed side beams 224. The increased distance between the opposed side beams may lead to having longer bridge beams 222, stabilizer bars 238 and guide tubes 239 between the opposed side beams 224, relative to the embodiment of FIG. 42. Longer bridge beams 222 may allow for an increased amount of rebar slots 226. Referring to FIGS. 67-71, an example is shown where three skeleton frame modules 201 of FIG. 47 are connected. The skeleton frame modules 201 may connect to each other through the ladder connectors 326A and 326B.

In some cases, plural forms 216 may be made by various adaptations of the methods herein. Plural forms 216 may be made by assembling plural skeleton modules into a single skeleton, and then molding the insulated panels thereon. Afterward, the panels themselves (but not the skeletons) may be cut, and the skeletons detached to produce plural smaller forms. For example, a user may make a four foot skeleton using two two foot skeletons, mold the EPS panels to provide a four foot form, and then hot wire cut just the panels, thereafter separating the ladders to produce two smaller forms.

Referring to FIGS. 73-78, an insulated concrete corner form 217 (FIG. 78) is illustrated, made using one or more concrete forms 216 and one or both of outer and inner corner angle members 341, 340 (FIGS. 73-78). Referring to FIG. 78, a corner form 217 may have first and second insulated concrete forms 216′ and 216″, and outer and inner corner angle members 341 and 340, respectively. The first and second insulated concrete forms 216′ and 216″ may be independent forms or may be two parts of a single form that is cut and/or bent into the corner configuration. The ends 216A (for example the longitudinal ends defined by ends 204A or 204B of ladders 204) abut one another with the first and second insulated concrete forms 216′, 216″ oriented in a corner configuration as shown. Exterior and interior abutment interfaces are defined (for example defined as angle member corner axes 350) between the ends 216A of the first and second insulated concrete forms, along the edges of the forms, with the ends 216A contacting or in close proximity with one another. Outer and inner corner angle members 341, 340 may be secured to the exterior faces and interior faces 234, 236, respectively, of the first and second insulated concrete forms 216′, 216″. Thus, outer corner angle members 341 may be secured to exterior faces 234 of the forms 216′ and 216″, and inner corner angle members 340 may be secured interior faces 236 of the forms 216′, 216″. The outer and inner corner angle members 341, 340 may bridge the exterior and interior abutment interfaces, respectively. In a method of making the form 217, the ends 216A may be abutted and the angle members 341, 340 secured to the forms 216′, 216″. Referring to FIGS. 73-78, the corner angle members have a suitable shape. The outer or inner corner angle members, or both, may have first and second corner wings 352 defined about a respective angle member corner axis 350.

Referring to FIG. 78, the first and second corner wings 352 may secure the outer and inner corer angle members 341, 340, to the exterior faces 234 and interior faces 236, respectively, of the first and second insulated concrete forms 216. Referring to FIGS. 73-78, first and second corner wings 352 may comprise lateral fingers (shown), which are spaced to define gaps 356 between adjacent fingers. In the example shown, the fingers have a regular undulating pattern from a top to a bottom end. The lateral fingers may define apertures 354, in which fasteners 346 may be secured through in use into the first and second insulated concrete forms 216′, 216″. In some cases, the corner wings 352 are hinged. The wings 352 may extend from a central cover portion 358, which may be rectangular as shown.

Referring to FIG. 78, the angle members 341, 340 may secure to the forms 216 by a suitable method. One or more fasteners 346, such as bolts or pins, may be passed through the forms 216 and members 341, 340. In the example shown, one or more fasteners 346 (with or without other fastener accessories such as washers and/or nuts 348 are secured through the first corner wing 352 of the outer corner angle member 341, into the first insulated concrete form 216′, and into the first corner wing 352 of the inner corner angle member 340. In the example shown, one or more fasteners 346 are secured through the first corner wing 352 of the outer corner angle member 341, into the second insulated concrete form 216″, and into the first corner wing 352 of the inner corner angle member 340. Fasteners 346 may be secured at various locations along a height of the corner form.

Referring to FIG. 78, the corner form 217 may have a suitable internal cavity 324. The concrete receiving cavities 324′, 324″ of the forms 216′, 216″, respectively, may be linked to form a continuous concrete receiving cavity as shown. A continuous cavity permits concrete to set in a stable, relatively high-strength configuration wrapping around the corner. Rebar 390 may be inserted within the continuous concrete receiving cavity 324 to follow the corner configuration and laterally extend between the first and second concrete forms 216′, 216″. In the example shown the rebar 390 is bent at ninety degrees (the angle of the corner) and inserted into the cavity 324 to span or bridge the corner, increasing the strength of the form 217 and the resulting wall. The rebar 390 may rest upon the ladders 204 of the form 217 as described elsewhere in this document. In some cases, other reinforcing materials may be used such as fibers, for example TUF-STRAND™ made by Euclid Chemical.

Referring to FIGS. 73-78, prior to making the form 217, various steps may be carried out. One or both of the first and second insulated concrete forms 216′, 216″ may be formed, for example by cutting a larger planar insulated concrete form 216, and/or by bending such a form 216. One or both of the angle members 341, 340 may be formed. Referring to FIGS. 75-78, in some cases plural outer corner angle members 341 are formed using a blank sheet of material, for example sheet metal. Plural outer corner angle members 341 may be profiled, and cut out in a flat configuration from a sheet of material. The lateral fingers of the members 341 may intermesh between adjacent outer corner angle members 341 prior to cutting as shown. Referring to FIG. 77, once cut out, the members 341 may be bent, for example using a box bender or other suitable machine, about the respective angle member corner axis 350, into a suitable corner angle 360 (FIG. 78) as corresponds with the angle of the corner form 217 itself. Referring to FIGS. 73-74, in some cases plural outer corner angle members 341 are formed using a blank sheet of material, for example sheet metal. Plural inner corner angle members 340 may be profiled, and cut out in a flat configuration from a sheet of material. The lateral fingers of the members 340 may intermesh between adjacent outer corner angle members 340 prior to cutting as shown. Referring to FIG. 78, once cut out, the members 340 may be bent, for example using a box bender or other suitable machine, about the respective angle member corner axis 350, into a suitable corner angle 360 (FIG. 78) as corresponds with the angle of the corner form 217 itself The angle members 341, 340 may serve to close off and seal the end edge interfaces between the forms 216′, 216″, to facilitate retention of concrete poured thereafter within the cavity 324. Referring to FIGS. 73, 75, and 78, a width 380 (FIGS. 73, 75) of the angle members 340 may be selected such that when assembled and secured to form 217, the wings 352 of both angle members 341, 340 are long enough to permit fasteners 346 to insert transverse to the forms 216 themselves, passing through both members 341, 340.

Referring to FIG. 80, another embodiment of a corner form is shown. In the example shown, one or more fasteners, such as fasteners 346′″ may be passed through both the outer corner angle member 341 and the inner corner angle member 340. Securing may comprise passing one or more fasteners, such as fasteners 346′, through the respective angle member corner axes 350 (apexes) of both the outer corner angle member 341 and the inner corner angle member 340. Fasteners, such as fasteners 346″ may be passed through both wings of the outer corner angle member 341. Such a structure may add corner strength relative to the embodiment of FIG. 78. Nuts 348 (such as nuts 348′, 348″, and 348′″) may be used. After securing the corner form together, concrete may be poured into the concrete receiving cavity 324. The concrete may be allowed to set. Once set, or sufficiently set, one or both the outer and inner corner angle members 341, 340 may be removed. For example, respective nuts 348 may be unsecured, and the respective angle members thereafter removed. The ends of the fasteners 348 may be cut, for example ground down or sawed off, to a sufficient extent, for example to flush with the exterior surfaces of the panels 232. The removed angle members may be reused. Referring to FIGS. 81-83, various embodiments of angle members are shown that may be used in the embodiment of FIG. 80. The angle members may have fingers (FIG. 81) or not (FIGS. 82-83). Apertures 354 may be provided as guides for fasteners 346 in use. Some of the apertures, such as apex apertures 354B or finger apertures 354C, may be slots, for example to permit mounting of fasteners 346 at an angle relative to normal. Others, such as apertures 354A may be circular. Slots may also be used to accommodate imperfect alignment of fasteners 346 or for other reasons to provide flexibility of installation. Fasteners 346 may be suitable fasteners, such as bolts, or tie rods, for example made of fiber glass or metal. Corner angle members may be made of suitable materials, such as steel or other metal, or in some cases polymers. Corner angle members may be formed from a blank and bent to a desired corner angle, for example using a corner break or other suitable bending machine.

In some cases, plural forms 216 may be made by various adaptations of the methods herein. Plural forms 216 may be made by assembling plural skeleton modules into a single skeleton, and then molding the insulated panels thereon. Afterward, the panels themselves (but not the skeletons) may be cut, and the skeletons detached to produce plural smaller forms. For example, a user may make a four foot skeleton using two two foot skeletons, mold the EPS panels to provide a four foot form, and then hot wire cut just the panels, thereafter separating the ladders to produce two smaller forms.

Any use herein of any terms describing an interaction between elements is not meant to limit the interaction to direct interaction between the subject elements, and may also include indirect interaction between the elements such as through secondary or intermediary structure unless specifically stated otherwise. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements. It will be apparent that changes may be made to the illustrative embodiments, while falling within the scope of the present technology. As such, the scope of the following claims should not be limited by the preferred embodiments set forth in the examples and drawings described above, but should be given the broadest interpretation consistent with the description as a whole. Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology. References to up, down, top, base, vertical and horizontal are not intended to require orientations relative to the direction of gravitational acceleration on the Earth unless context dictates otherwise. Length and height are understood to refer to edge-to-edge dimensions that are perpendicular to one another along the faces of the forms 200, with width denoting thickness of form between panels 232. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. An apparatus comprising:
a concrete form skeleton frame module, having:
a ladder, formed of opposed side beams laterally spaced from one another by a plurality of bridge beams; and
a plurality of studs, arrayed and spaced from one another along a longitudinal length of exterior sides of the opposed side beams of the ladder;
in which the opposed side beams define first and second ladder ends of the ladder, with each of the first and second ladder ends having a ladder connector, with the ladder connectors of the first and second ladder ends being adapted to mechanically connect to ladder connectors of second and first ladder ends, respectively, of a ladder of a second concrete form skeleton frame module, which is identical to the concrete form skeleton frame module, if the second concrete form skeleton frame module is positioned in use adjacent the concrete form skeleton frame module such that the first or second ladder ends of the concrete form skeleton frame module abut the second or first ladder ends, respectively, of the second concrete form skeleton frame module;
in which the plurality of studs each define first and second stud ends, with each of the first and second stud ends having a stud connector, with the stud connectors of the first and second stud ends being adapted to mechanically connect to stud connectors of second and first stud ends, respectively, of a plurality of studs of a third concrete form skeleton frame module, which is identical to the concrete form skeleton frame module, if the third concrete form skeleton frame module is positioned in use adjacent the concrete form skeleton frame module such that the first or second stud ends of the concrete form skeleton frame module abut the second or first stud ends, respectively, of the third concrete form skeleton frame module; and
in which the concrete form skeleton frame module is integrally formed as a monolithic unit.

2. The apparatus of claim 1 in which the concrete form skeleton frame module is integrally molded as a monolithic unit.

3. The apparatus of claim 1 in which the ladder connectors and the stud connectors are male-female connectors.

4. The apparatus of claim 3 in which the ladder connectors comprise female grooves and male tongues.

5. The apparatus of claim 4 in which:
the female groove opens in a direction parallel to an axis of the opposed side beams;
the male tongue comprises a lateral shelf; and
one or both of the female groove and male tongue are tapered in width in a direction toward the other of the female groove and male tongue when connected.

6. The apparatus of claim 1 in which the first, second, or first and second ladder ends comprise apertures to permit a fastener to pass through to secure the concrete form skeleton frame module and the second concrete form skeleton frame module together.

7. The apparatus of claim 1 in which the stud connectors are irreleasable connectors.

8. The apparatus of claim 1 in which the plurality of studs comprises three or more studs along each of the opposed side beams of the ladder.

9. The apparatus of claim 1 in which the ladder is oriented horizontally and the plurality of studs are oriented vertically.

10. The apparatus of claim 1 in which each stud comprises one or more reinforcing ridges.

11. The apparatus of claim 9 in which the one or more reinforcing ridges are on an exterior face of the stud.

12. The apparatus of claim 11 in which:
the one or more reinforcing ridges project from a stud body of the stud;
the one or more reinforcing ridges and stud body define foam cavities;
the foam cavities are bounded by the one or more reinforcing ridges; and
a base of each foam cavity is defined by the stud body.

13. The apparatus of claim 9 in which the one or more reinforcing ridges comprise a plurality of axial ridges.

14. The apparatus of claim 9 in which the one or more reinforcing ridges comprise a plurality of cross ridges.

15. The apparatus of claim 1 in which the stud connectors comprise buckles.

16. The apparatus of claim 1 in which each opposed side beam comprises one or more reinforcing ridges.

17. The apparatus of claim 16 in which the one or more reinforcing ridges comprise a plurality of axial ridges.

18. The apparatus of claim 17 in which the axial ridges extend a longitudinal length of the opposed side beam.

19. The apparatus of claim 17 in which the one or more reinforcing ridges comprise a lattice of structural members.

20. The apparatus of claim 19 in which the lattice is oriented in a plane perpendicular to the exterior side of the opposed side beam.

21. The apparatus of claim 19 in which each stud mounts to the opposed side beam via the lattice.

22. The apparatus of claim 1 in which each stud mounts to an opposed side beam via a lateral stem.

23. The apparatus of claim 22 in which the lateral stem comprises a gusset plate.

24. The apparatus of claim 23 in which the lateral stem is oriented such that an apex of the lateral stem is adjacent to the opposed side beam and a long edge of the lateral stem is adjacent an interior face of the stud.

25. The apparatus of claim 1 in which the plurality of bridge beams each comprise a plurality of one-way rebar connectors.

26. The apparatus of claim 25 in which the one-way rebar connectors comprise tapered spring tabs that are able to flex outwardly to receive the rebar, and close thereafter in order to enclose the rebar within a rebar slot.

27. The apparatus of claim 1 further comprising a plurality of concrete form skeleton frame modules connected together to form a concrete form skeleton frame via connections between the ladder connectors or stud connectors of adjacent concrete form skeleton frame modules of the concrete form skeleton frame.

28. The apparatus of claim 1 in which a plurality of lateral stems extend from the exterior sides of the opposed side beams to interior sides of the plurality of studs to separate the interior sides of the plurality of studs from the opposed side beams of the ladder to define opposed insulated form panel gaps therebetween.

29. The apparatus of claim 1 further comprising opposed insulated form panels, each having exterior and interior faces, with the interior faces mounted to the ladder and spaced apart from one another to form an insulated concrete form.

30. The apparatus of claim 29 in which the opposed insulated form panels comprise expandable polymer material.

31. The apparatus of claim 29 in which the plurality of studs and the opposed side beams are embedded within the opposed insulated form panels.

32. The apparatus of claim 1 in which each stud of the plurality of studs is fifteen inches tall or less.

33. A mold structured to form the concrete form skeleton frame module of the apparatus of claim 1.

34. A method comprising molding the concrete form skeleton frame module of the apparatus of claim 1.

35. The method of claim 34 further comprising forming a concrete form skeleton frame by connecting adjacent concrete form skeleton frame modules together.

36. The method of claim 34 further comprising molding opposed insulated form panels to the apparatus, each of the opposed insulated form panels having exterior and interior faces, with the interior faces mounted to the ladder and spaced apart from one another to form an insulated concrete form.

37. The method of claim 28 further comprising cutting the insulated concrete form to length or height.

38-62. (canceled)
